(19) United States
(12) Patent Application Publication
(10) Pub. No.: US 2020/0034770 A1
(43) Pub. Date: Jan. 30, 2020

(54) WORK PROCEDURE SYSTEMS AND METHODS OF USE

(71) Applicant: Ameren Corporation, St. Louis, MO (US)

(72) Inventors: Anthony Jennings, St. Louis, MO (US); Nathan Boosinger, St. Louis, MO (US); Matthew Johnson, St. Charles, MO (US)

(73) Assignee: Ameren Corporation, St. Louis, MO (US)

(21) Appl. No.: 16/520,686

(22) Filed: Jul. 24, 2019

Related U.S. Application Data
(60) Provisional application No. 62/702,719, filed on Jul. 24, 2018.

(51) Int. Cl. G06Q 10/06; G06F 16/93

(52) U.S. Cl. CPC G06Q 10/06316; G06F 16/93

(57) ABSTRACT

A system for converting a work procedure document into a mobile application and mobile applications for executing work procedures are disclosed. The conversion system converts work procedure data in the document into a converted format. In some cases, the converted formatted is consumable by a mobile application. The conversion system can be programmed to identify steps and sub-steps in the work procedure based on business-specific formatting characteristics common to work procedure documents. The mobile application can be configured to generate a controlled workflow for a work procedure on a mobile device. The workflow can prompt a user to provide inputs to the mobile device indicating performance of steps in the work procedure.

### CROSS-REFERENCE TO RELATED APPLICATION

This application claims priority to U.S. Provisional Patent Application Ser. No. 62/702,719, filed Jul. 24, 2018, and entitled WORK PROCEDURE SYSTEMS AND METHODS OF USE, which is hereby incorporated by reference in its entirety.

### FIELD

This disclosure generally relates to a system that facilitates documentation of work procedures and to a system for converting work procedures to a converted format.

### BACKGROUND

Work procedure documents are used to standardize tasks and record work performed in various industries. For example, for certain tasks in a nuclear power plant, a work procedure document provides a list of the steps and sub-steps of the task. A technician annotates the document to make a record that each step and sub-step of the task is performed. For example, the technician can make a first mark (e.g., an open circle) on the document when a step or sub-step of the work procedure is begun and make a second mark (e.g., a slash through the open circle) when the step or sub-step of the work procedure is complete. In some cases, businesses or regulators require verification that one or more steps, sub-steps, or tasks in a work procedure document are performed. Work procedure documents can include signature or initials lines at which a technician can verify and authenticate that work has been performed. Work procedures can also include data blocks or other fields that prompt the technician to provide qualitative or quantitative data associated with the task being performed.

### SUMMARY

In one aspect, a work procedure conversion system comprises processor-executable software that when executed by a processor is configured to receive pre-conversion work procedure data in a pre-conversion format. Work procedure items are identified in the pre-conversion work procedure data based on characteristics of the pre-conversion format. Converted work procedure data in a converted format are generated. The converted work procedure data represents the identified work procedure items in the converted format.

In another aspect, a method of converting work procedure documents for a business comprises identifying business-specific formatting characteristics of the work procedure documents for the business. Steps in the work procedure documents of the business are identified based on the business-specific formatting characteristics. A step model tree is generated for each of the work procedure documents including an ordered sequence of step models representing the steps of the work procedure.

In another aspect, an electronic work procedure system comprises a memory storing a processor-executable work procedure application. The work procedure application is configured when executed by the processor to generate a controlled workflow for a work procedure on a mobile device. The workflow prompts a user to provide inputs to the mobile device indicating performance of steps in the work procedure.

Other aspects and features will be apparent hereinafter.

### BRIEF DESCRIPTION OF THE DRAWINGS

FIG. 1 is a schematic diagram of an electronic work procedure system;

FIG, 2 is a schematic diagram of a work procedure converter;

FIG. 3 is a flow chart illustrating steps of a work procedure conversion process;

FIG. 4 is a flow chart illustrating steps of another work procedure conversion process; and

FIGS. 5-106 are screen shots illustrating use of a work procedure mobile application.

Corresponding reference characters indicate corresponding parts throughout the drawings.

### DETAILED DESCRIPTION

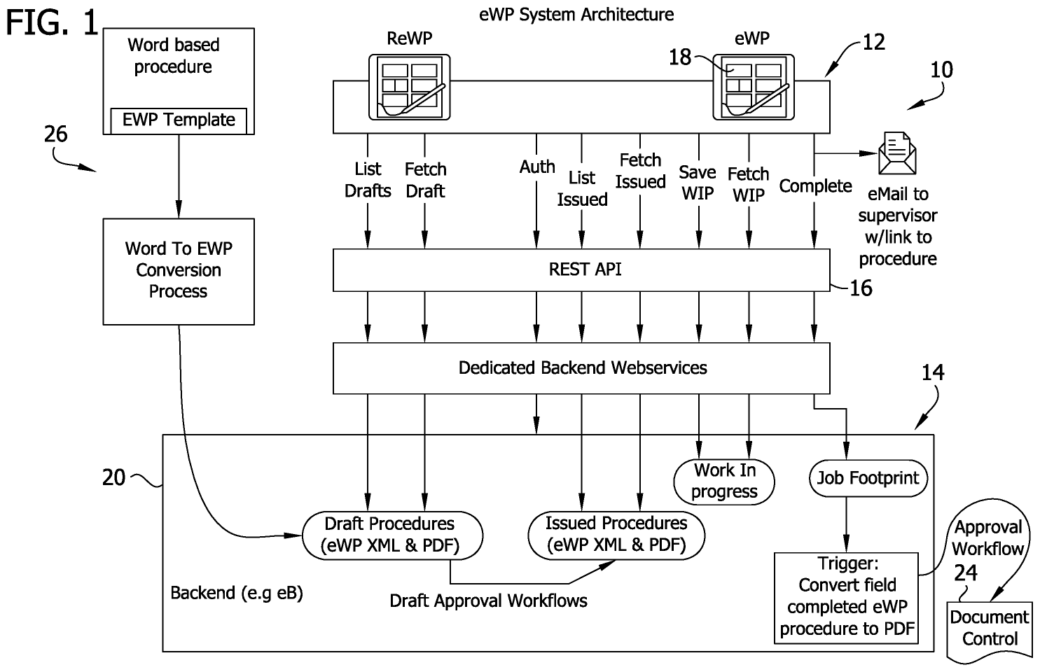

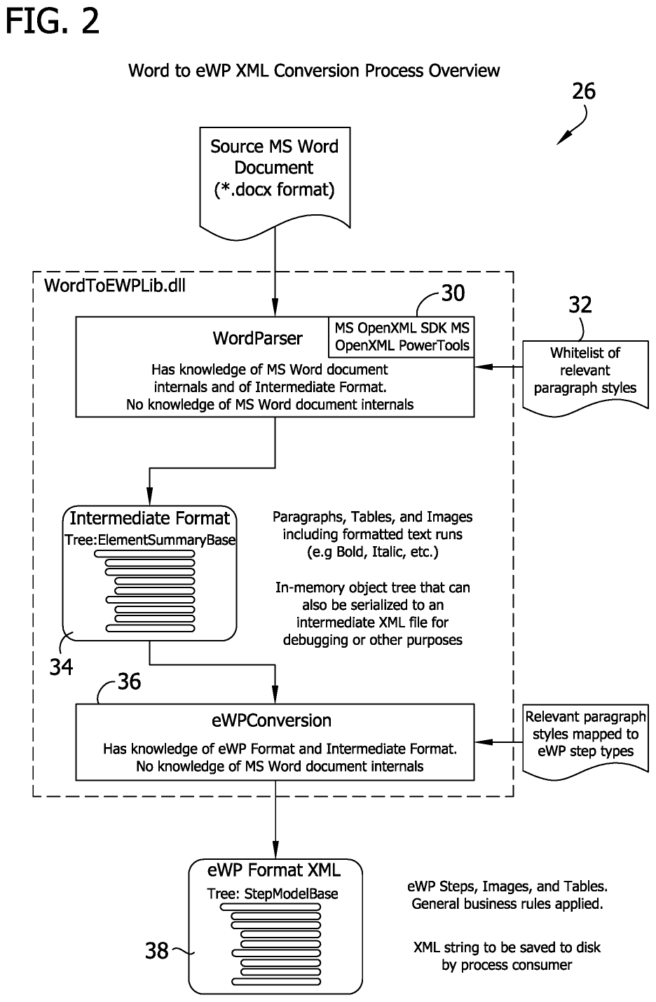

Referring to FIG. 1, an electronic work procedure system is generally indicated at reference number 10. The electronic work procedure system 10 comprises a front end 12, a back end 14, and an API layer 16 that provides communication between the front end and the back end. As will be explained in further detail below, the front end 12 comprises a mobile application (broadly, an electronic work procedure application) that is configured to generate a controlled workflow for an electronic work procedure on a mobile device 18 (broadly, an electronic user interface). The back end 14 comprises a work procedure database 20 that stores work procedures in a format that the front end application 12 can use to generate the controlled workflow s.

In particular, the work procedure database 20 is configured to store draft and issued work procedures, as well as work-in-progress data for work procedures being executed. The front end application 12 is configured to present the draft procedures to administrative users, who can use the front end mobile application 12 in a review mode to review, revise, validate and ultimately issue the draft procedures. The front end mobile application 12 is also configured to generate controlled workflows on the mobile device 18 based on the issued work procedures in the formatted work procedure database 20. The controlled workflows prompt a user to provide inputs to the mobile device 18 that document performance of the work procedure as prescribed by the terms of the work procedure. As a work procedure is performed, the front end mobile application 12 stores work in progress data in the work procedure database 20. Different users can access work procedures stored in the work procedure database 20 at different times such that work procedures can be completed over discontinuous periods of time and by more than one user. When a user completes the controlled workflow , the application can send an email with the completed procedure to a supervisor. In addition, the mobile application automatically stores all completed workflows in a document control database 24.

The illustrated electronic work procedure system 10 includes a work procedure converter 26 that is configured to convert a work procedure from a pre-conversion format to a converted format. In one or more embodiments, the pre-conversion format is a full-featured XML format such as .docx. Suitably, the pre-conversion format is a conventional word processing format such as .docx. In certain embodiments, the converted format comprises a tree format, an elemental format, a lean XML format, a web format such as html, or a document format such as pdf. As will be explained in further detail below, the procedure converter 26 can convert the work procedure from an initial format to one or more intermediate converted formats before converting the work procedure to a final converted format. In one or more embodiments, the final converted format is consumable by the front end mobile application 12. For example, the final converted format can comprise a mobile application-consumable format that has a syntax that allows the mobile application to generate controlled workflow applications from work procedure data stored in the final converted format. In certain embodiments, the final converted format comprises a post-mobile application consumable format such as html or pdf. Intermediate converted formats can facilitate converting work procedure data stored in a common, commercially available word processing format (or other initial work procedure format) to a subsequent converted format. Each intermediate format and final format is understood to be a ‘converted format’ with respect to an earlier pre-conversion format from which it was created. Each initial format or intermediate format is also considered to be a ‘pre-conversion format’ with respect to any converted format to which the work procedure data is later converted.

Referring to FIG. 2, in the illustrated embodiment, the work procedure converter 26 is configured to convert a work procedure from a .docx format to a mobile-application consumable format from which the mobile application can generate a controlled mobile workflow for the work procedure. It will be understood that another converter tool (e.g., a pdf-to-.docx converter) could be used to convert the work procedure from an initial format to .docx before using the work procedure converter 26 shown in FIG. 2. Throughout the drawings, the mobile application-consumable format is referred to as ‘eWP XML;’ however, it will be understood that system 10 can use any suitable converted mobile application-consumable format without departing from the scope of the invention.

In general, the .docx work procedure comprises a live-text work procedure document and underlying XML data. In one or more embodiments, the document includes text in a multi-level list of steps and, in some embodiments, sub-steps of the work procedure. The steps and sub-steps can be ordered or unordered. The work procedure document can also include tables, images, and other types of data. As will be explained in further detail below, elements of the document can have formatting styles that are apparent in the underlying XML data and in some cases on the face of the document.

The work procedure converter 26 comprises a parser 30 that is configured to parse the .docx work procedure document into a flat list of elements. The parser 30 is configured to identify each paragraph, table, image, or other element in the work procedure document and generate a flat list of XML data for each of the individual elements. In some embodiments, the parser 30 is configured to remove from one or more of the elements extraneous XML data that is not relevant to the front end mobile application 12. Thus, in one or more embodiments, the output of the parser 30 is a flat list of element summaries.

The work procedure converter 26 further comprises an element filter 32. The element filter 32 is configured to remove one or more elements or element summaries that are not pertinent to the converted work procedure utilized by the front end mobile application 12. In one or more embodiments, the element filter 32 is a whitelist filter. For each implementation of the work procedure converter 26, the white list filter 32 (or other type of filter) may be configured in accordance with common business logic for the work procedure documents being converted. Prior to conversion, .docx work procedure documents are styled according to common business logic (e.g., styled according to the procedure-writing logic of a specific nuclear power plant). The whitelist filter 32 is configured to identify and ‘whitelist’ elements having styles that are required for creating converted work procedures used by the mobile application. The whitelist filter 32 removes any elements that are not whitelisted such that the flat list of elements produced by the parser 30 includes only whitelisted elements. The filtered output of the parser 30 is an intermediate format of the work procedure including a flat (unordered, non-hierarchical) list of element summaries 34 for the elements of the work procedure.

The work procedure converter 26 further comprises a tree builder 36. The tree builder 36 is configured to order the elements in the flat list into ordered hierarchical tree of element summaries and convert the ordered hierarchical tree of elements into an ordered hierarchical tree of step models 38, formatted in the mobile application-consumable format.

To create the tree of element summaries, the tree builder 36 determines the style of each element summary and builds the ordered hierarchical tree based on the styles. In one or more embodiments, the tree builder 36 has default logic that considers the styles of the element summaries in sequence. The style of the first element summary in the flat list is automatically determined to be the style associated with the highest parent level of the tree. Then, the tree builder 36 determines whether the style of the second element summary is the same as the first element summary. If the second element summary has the same style as the first, the second element is determined to be a sibling of the first. By default, the tree builder 36 would define an order to the first and second element siblings. For example, the tree builder 36 would determine that that the first element and the second element are respectively first and second in the sequence of the work procedure such that the first element must be completed before the second element can begin. However, if desired, whitelist metadata can be provided for a style that causes the tree builder 36 to automatically treat elements of that style as unordered elements in the tree of element summaries. If the second element summary has a different style than the first element summary, by default the tree builder 36 treats the second element summary as a child of the first element summary. But again, whitelist metadata can be used to establish business logic that treats elements of two different styles as ordered or unordered siblings instead of a child of the preceding element of the previous style. The tree builder 36 follows this same logic sequentially for each element in the flat list of element summaries 34. So for example, if the third element in the flat list has the same style as the first element, by default it is made an ordered sibling of the first element; if it has the same style as the second element, by default it is made an ordered sibling of the second element; and if it has a third style it is made a child of the second element. Additional metadata associated with element styles can be used to establish other tree-building logic. Element summary trees can also be constructed in other ways in other embodiments.

After the tree builder 36 constructs the element summary tree, it converts each element in the tree into a step model formatted for being used by the mobile application 12 to generate a controlled workflow for the respective work procedure. Each step model has attributes and properties that are derived from and compatible with the requirements of the mobile application 12. In certain embodiments, the step models are XML data structures. In one or more embodiments, the step model tree 38 retains the ordering and hierarchy of the element summary tree.

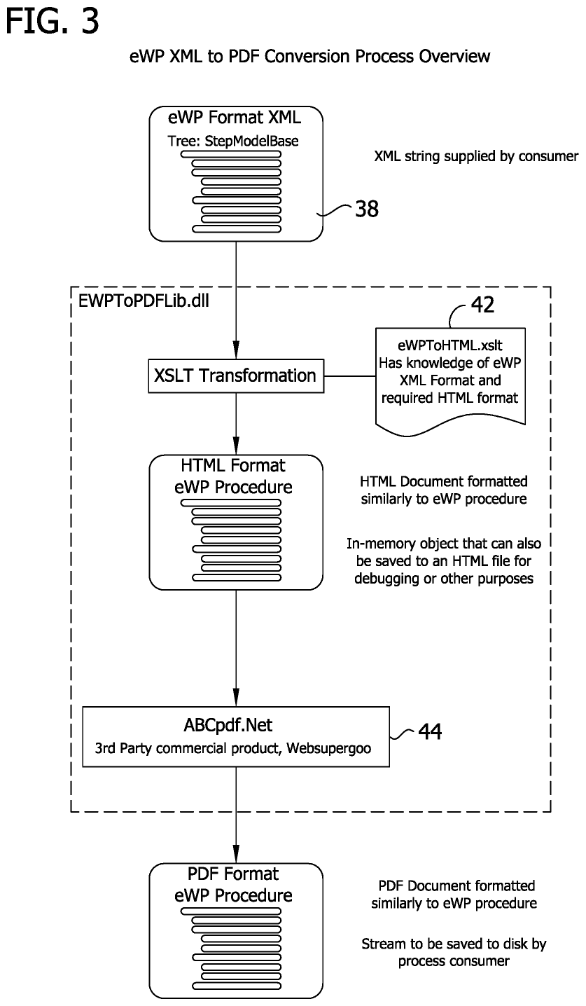

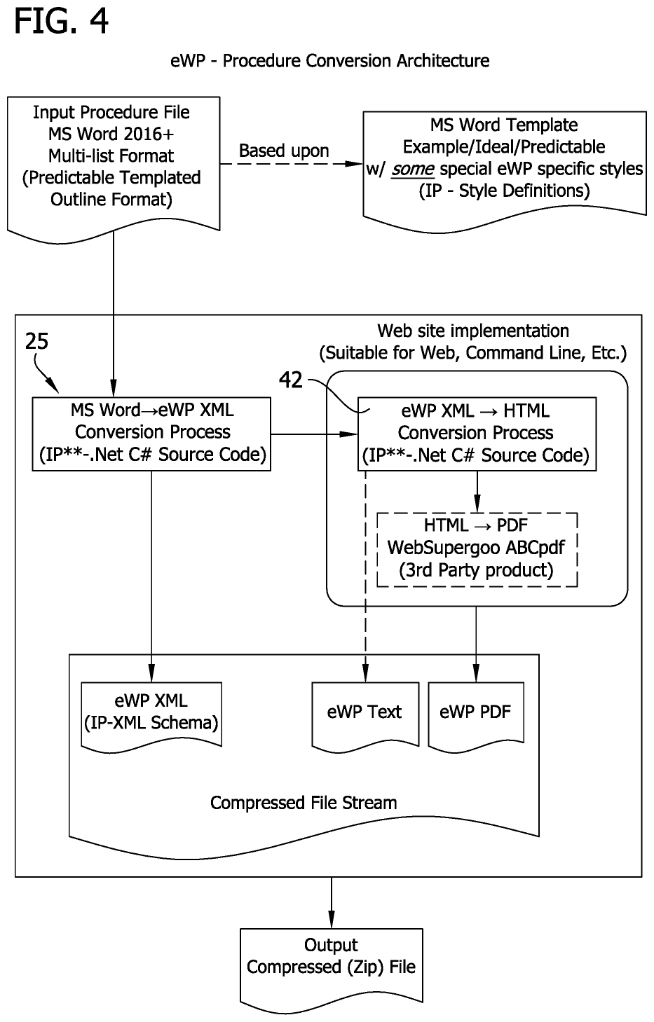

Referring to FIGS. 3 and 4, the tree 38 of formatted step models can be serialized and converted to an html format using an html converter tool 42. The html-formatted work procedure can be converted to pdf format using an html-to-pdf conversion tool 44 (e.g., an off-the-shelf conversion tool, WebSupergoo ACpdf).

It can be seen that, in one or more embodiments, a method of creating an electronic work procedure comprises formatting a .docx word procedure documents to have styles associated with the logic of the work procedure. For example, the document is formatted as a multi-level list, with each level having a respective style. Styles that are used for substantive content of the work procedure are whitelisted, and metadata is programed to set any styles that are used to indicate an unordered list or any plurality of styles that should be treated as siblings in the step model tree 38. Additional style metadata may be programmed to indicate where special work procedure inputs (signatures, initials, data values) are required in the work procedure document. The stylized .docx work procedure document is then fed to the work procedure converter 26. The work procedure converter 26 converts the XML data for the document into a flat, whitelist-filtered list of element summaries as explained above. The tree builder 36 then arranges the element summaries in a hierarchical tree and converts the tree of element summaries to a mobile-application consumable step model tree 38.

The work procedure converter 26 allows a user to maintain original .docx work procedures as the source of truth for electronic work procedures executed on a mobile application 12. After stylizing an original .docx work procedure document for being converted using the work procedure converter 26, revisions can be made to the .docx work procedure file in Microsoft Word by user having no skills in mobile application development. After the revisions are made, the document still retains the original styles used for converting the .docx work procedure to the mobile application-consumable step model tree 38. Thus, the revised document can be uploaded to the converter 26 for conversion without further programming.

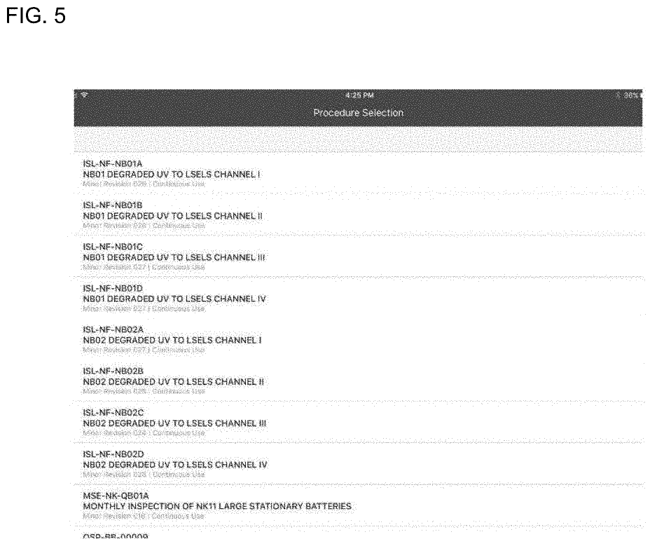

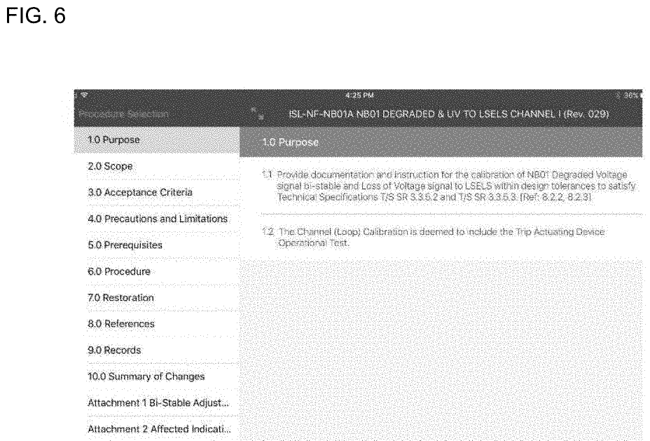

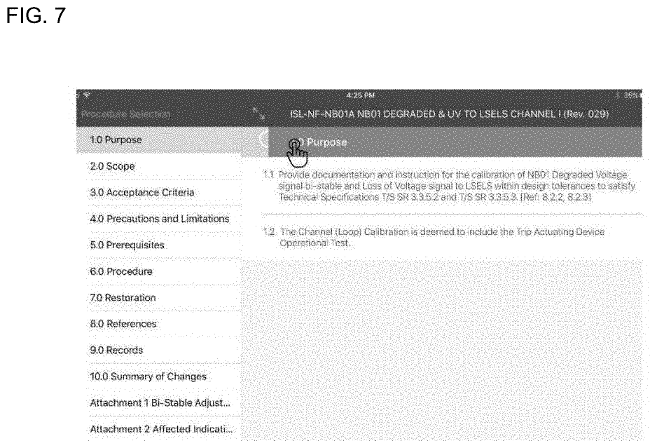

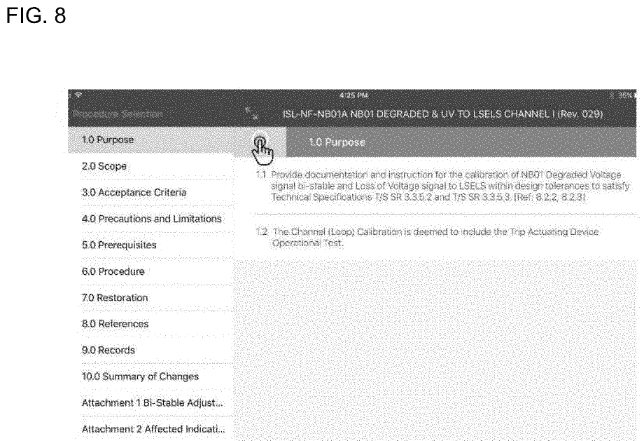

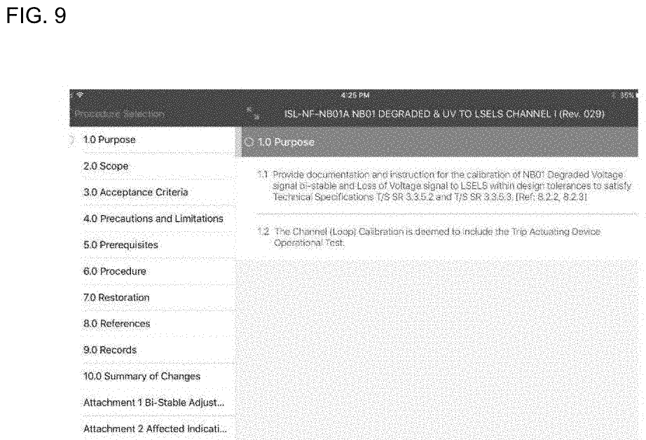

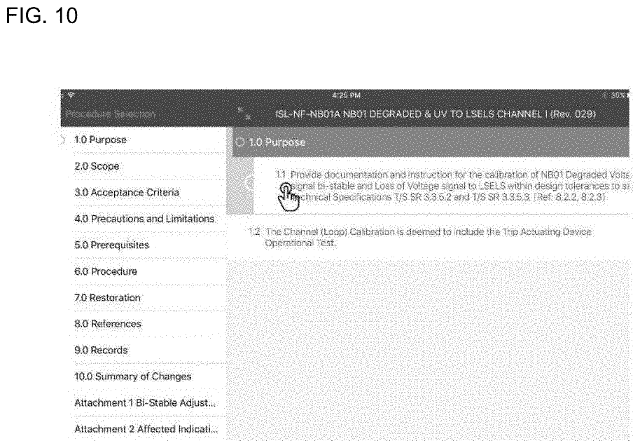

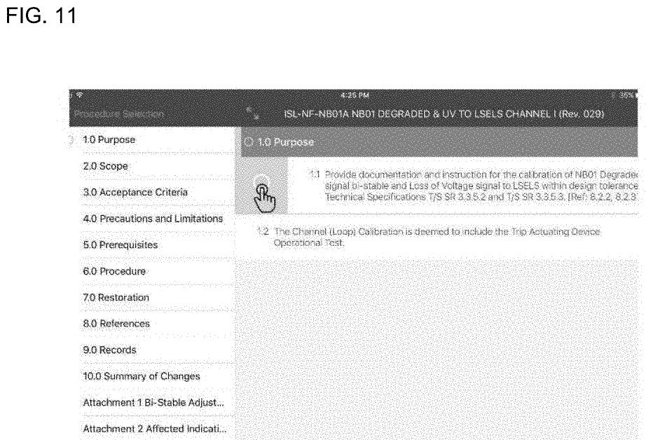

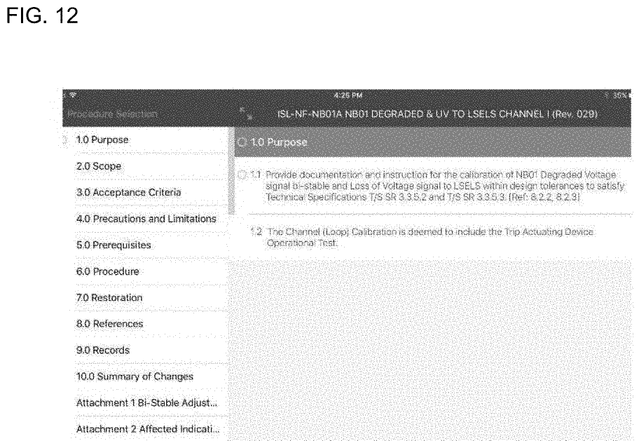

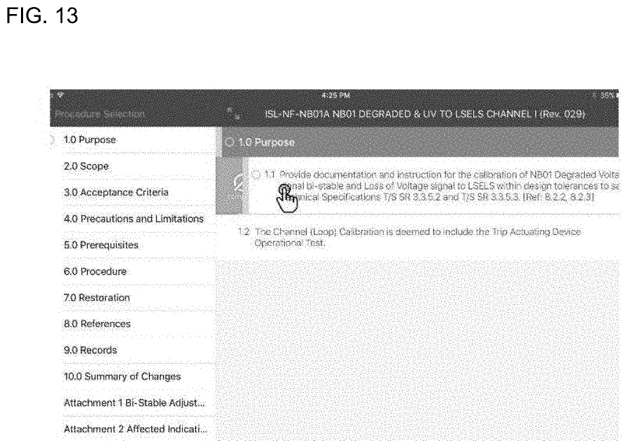

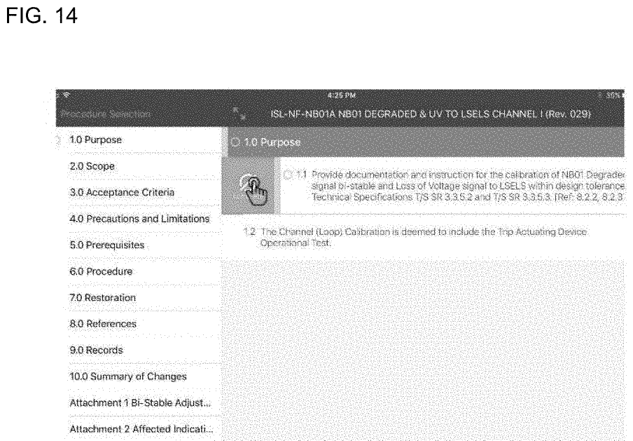

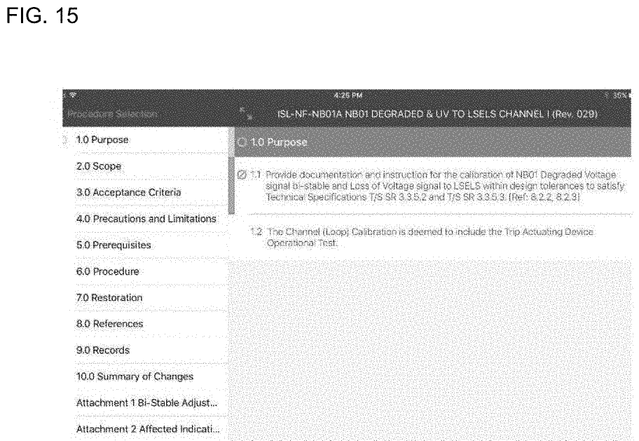

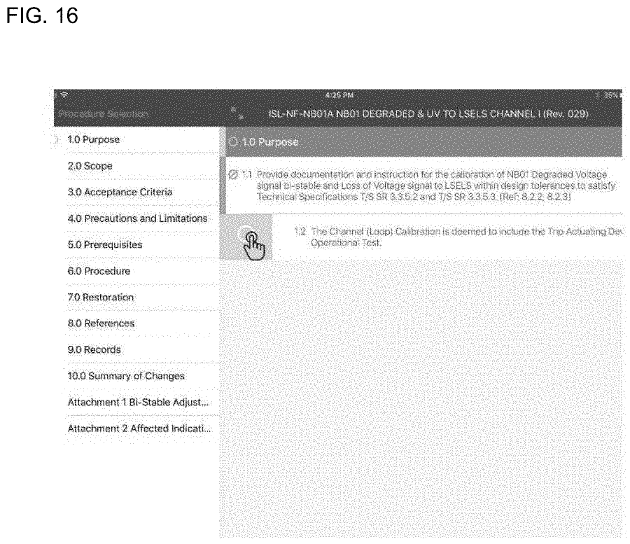

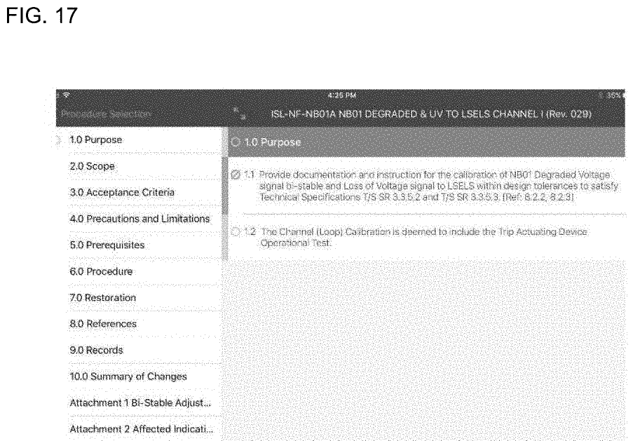

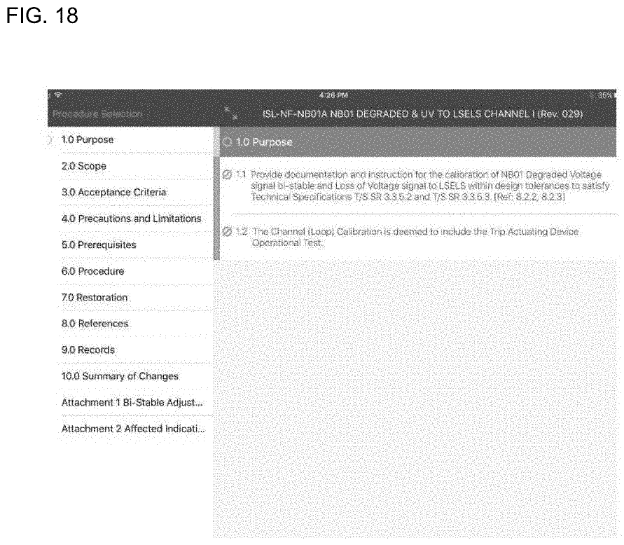

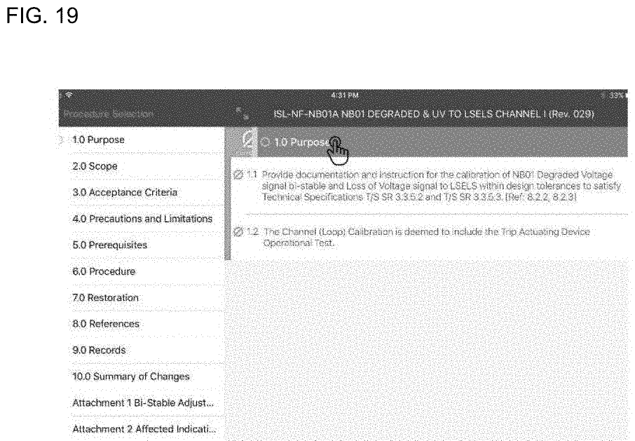

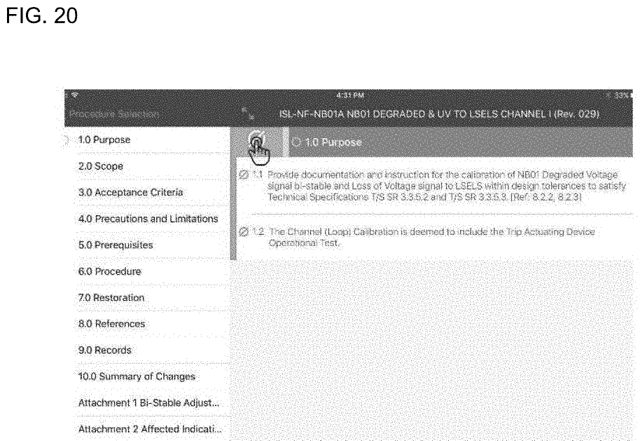

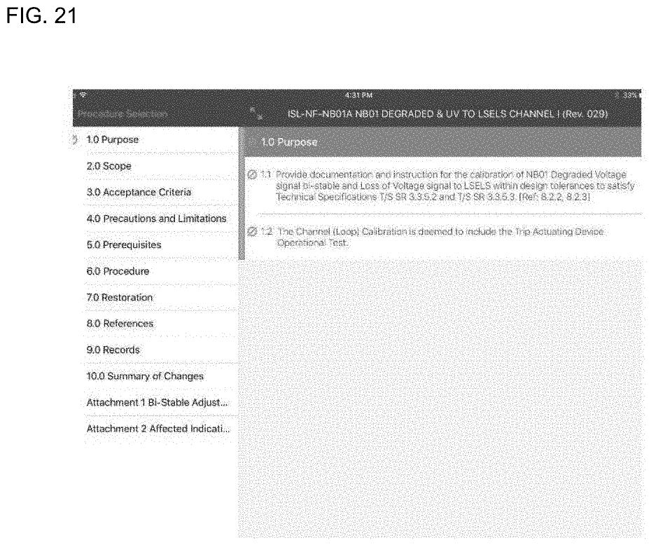

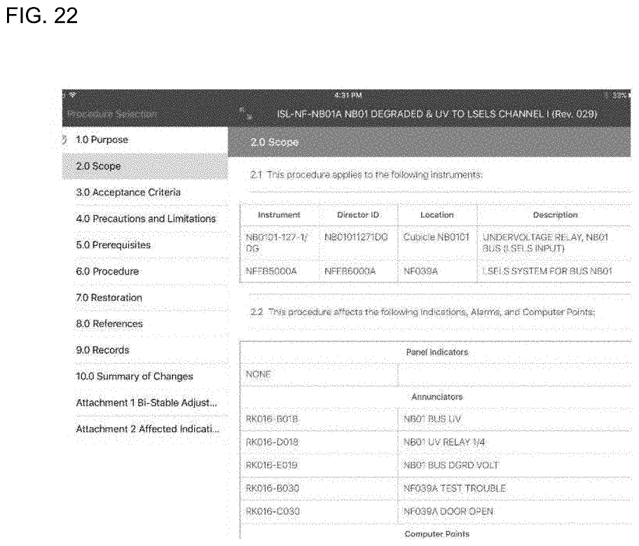

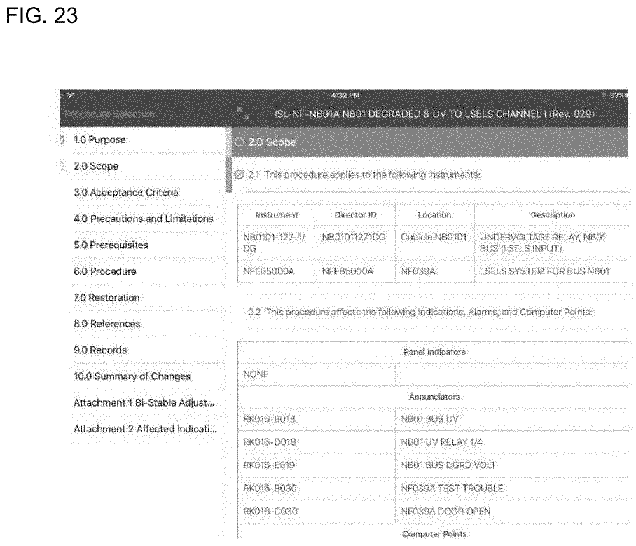

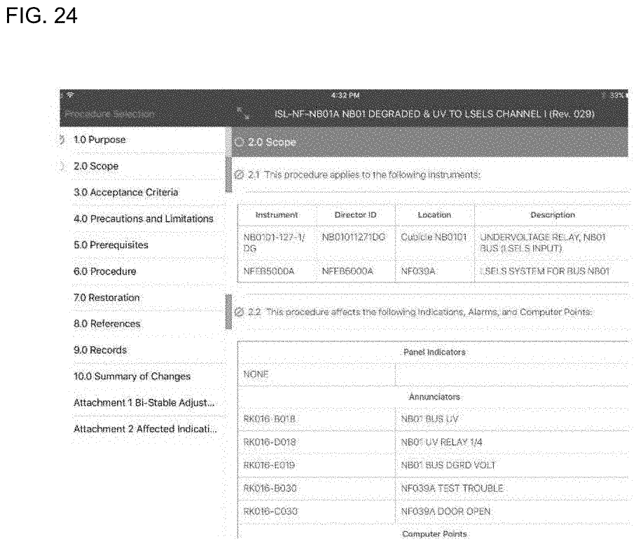

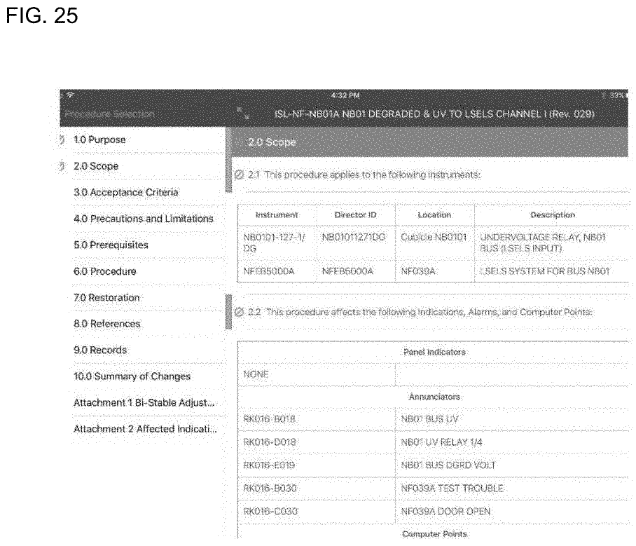

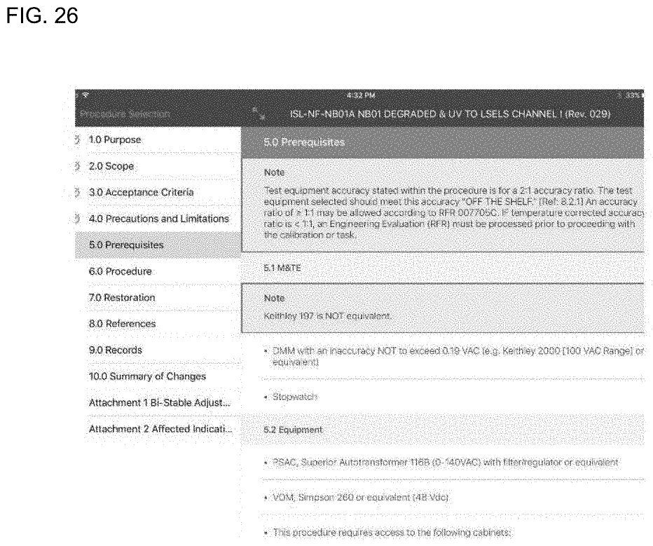

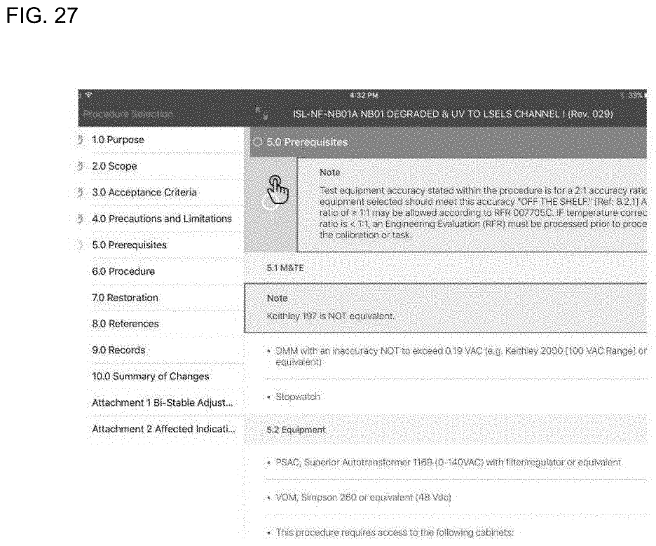

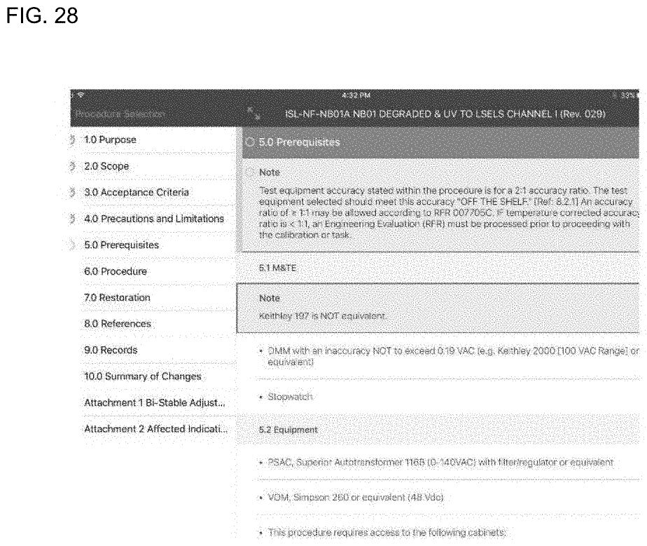

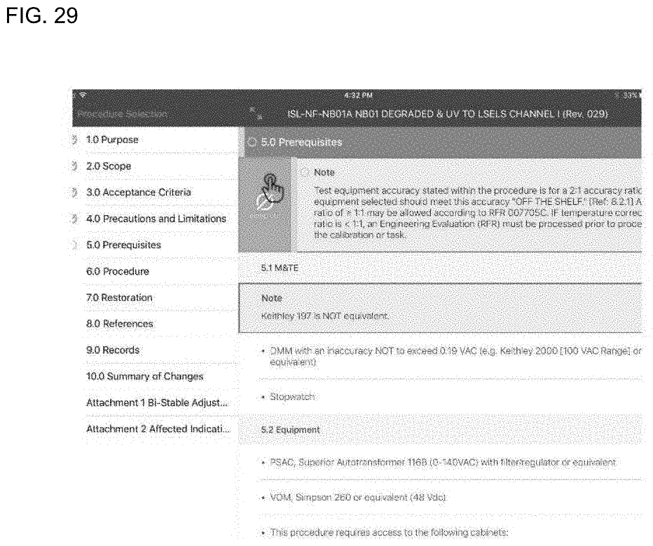

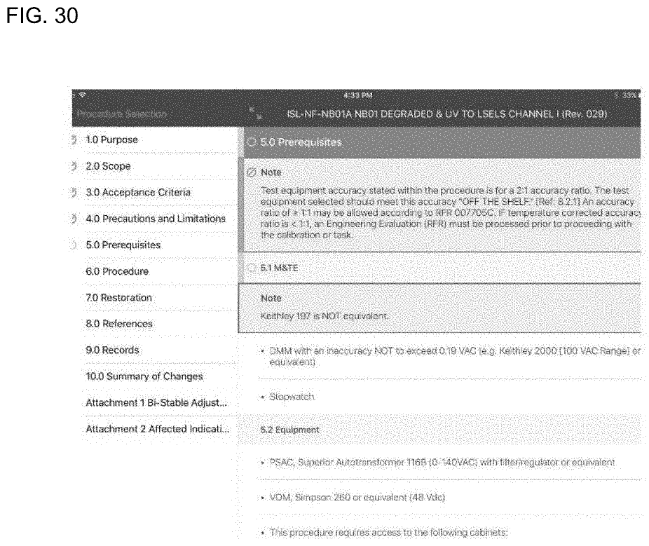

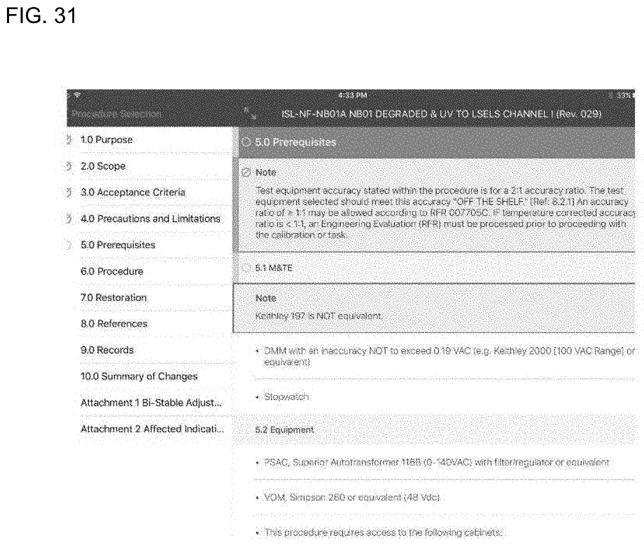

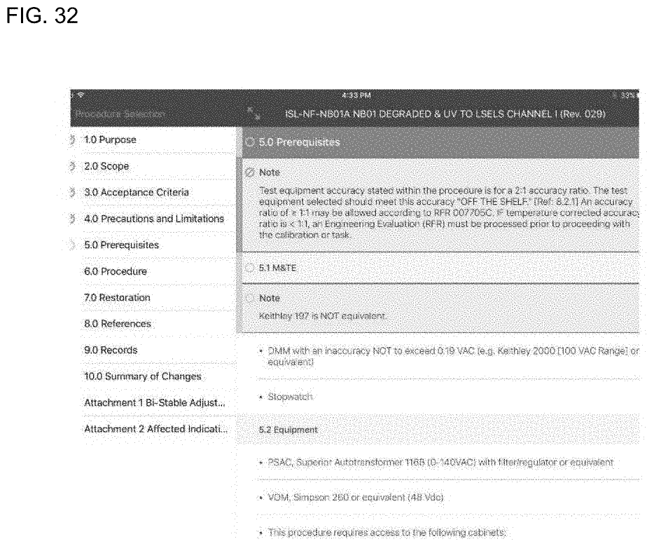

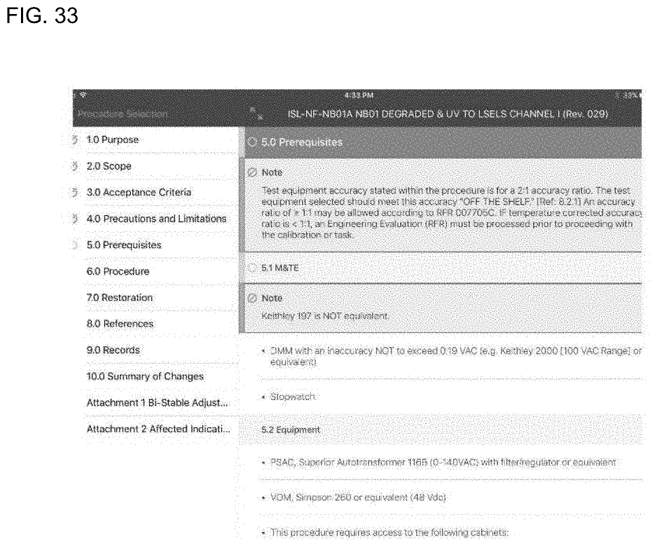

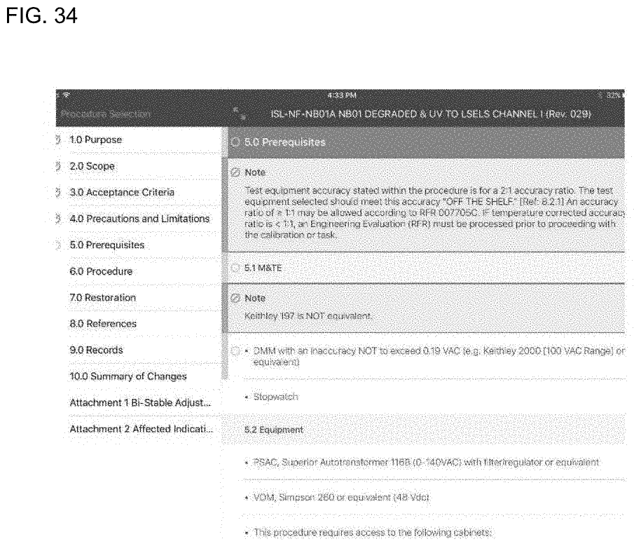

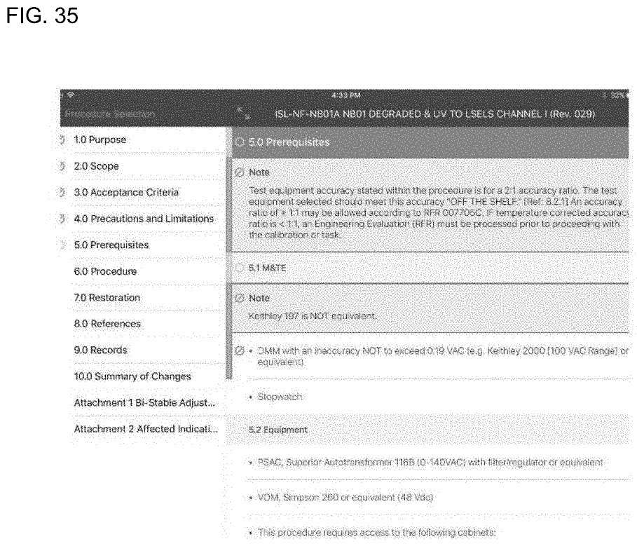

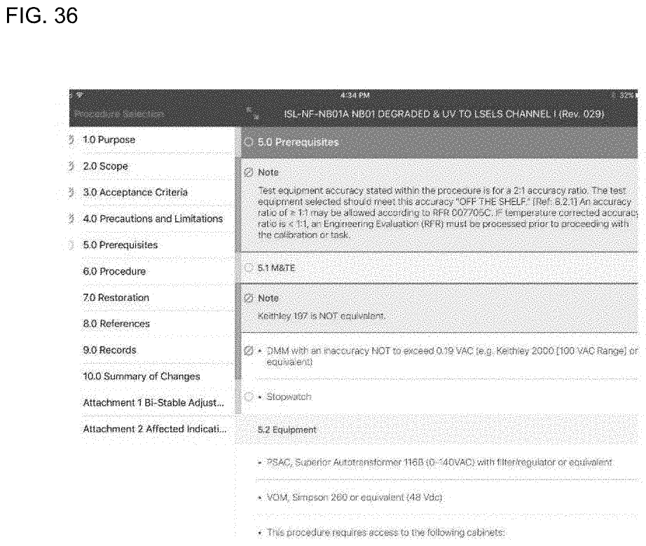

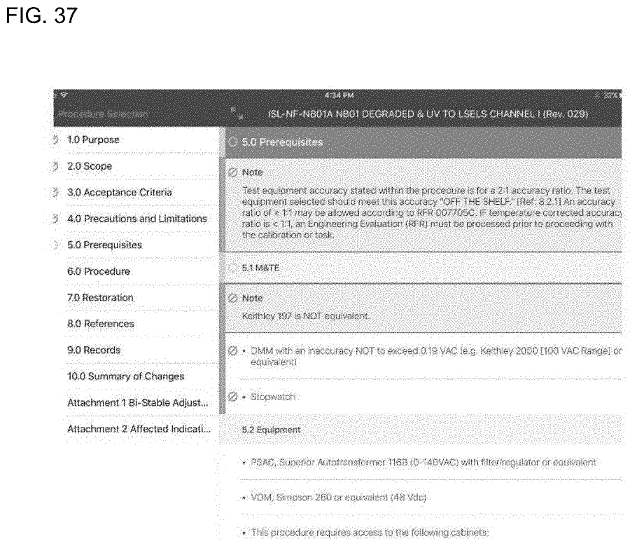

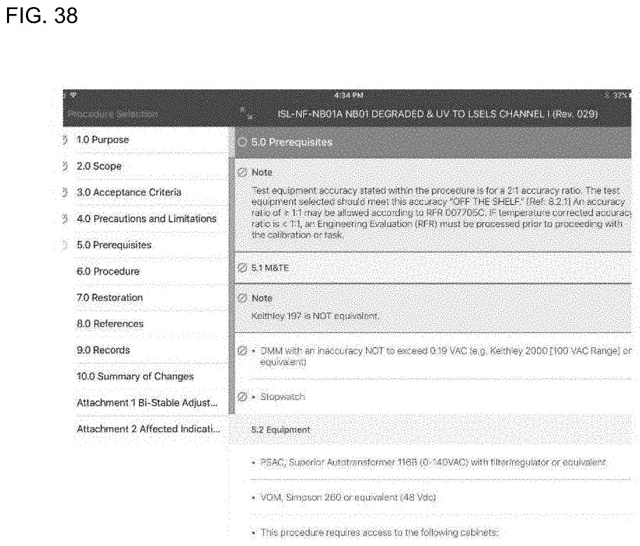

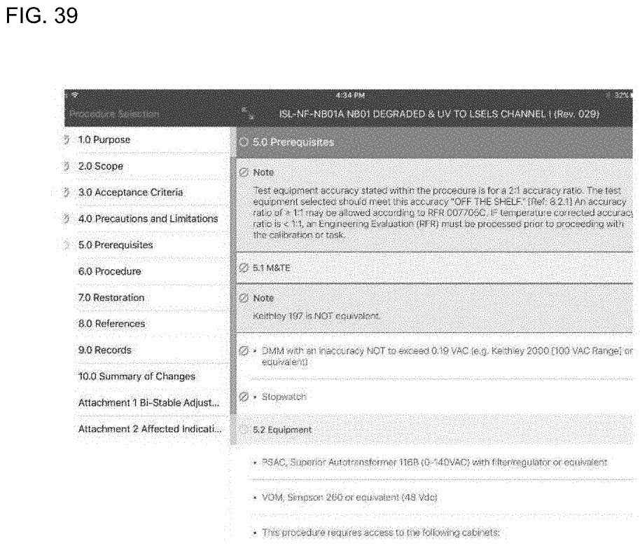

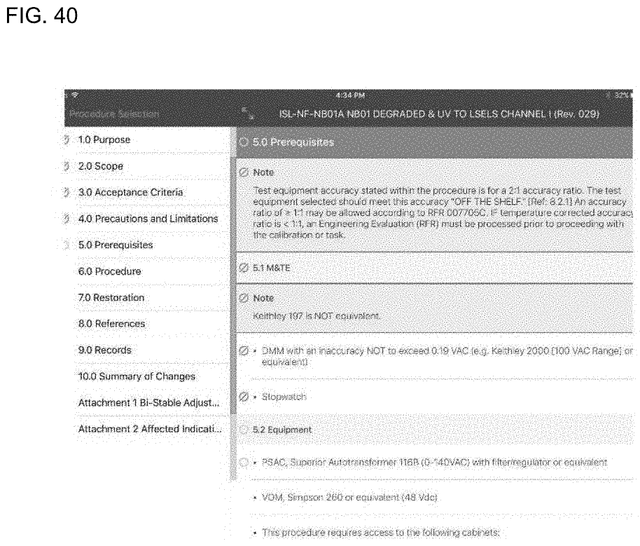

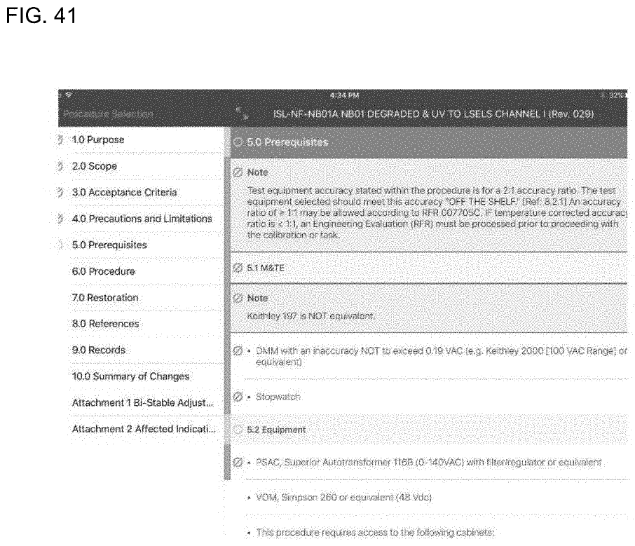

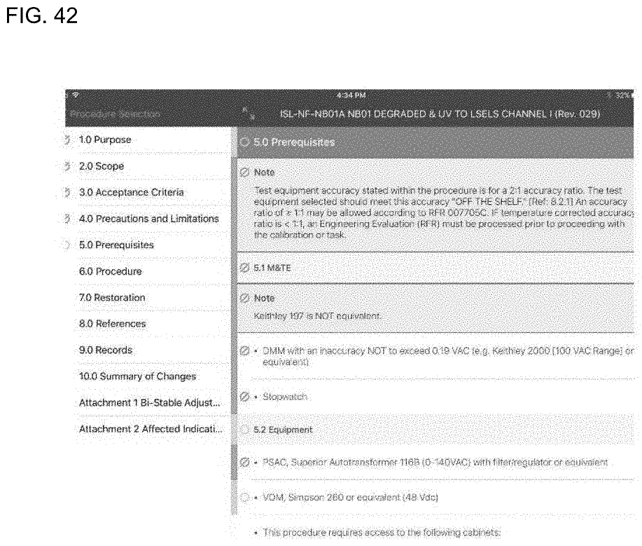

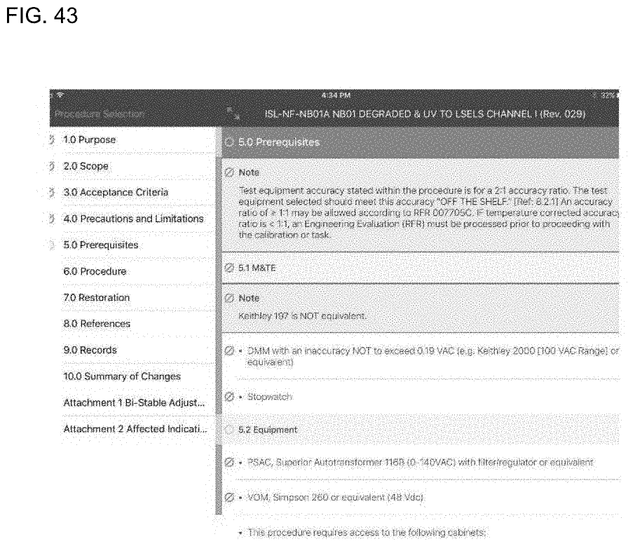

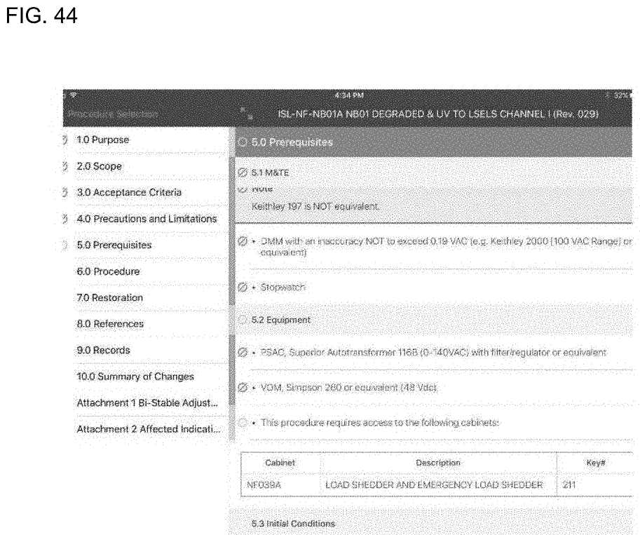

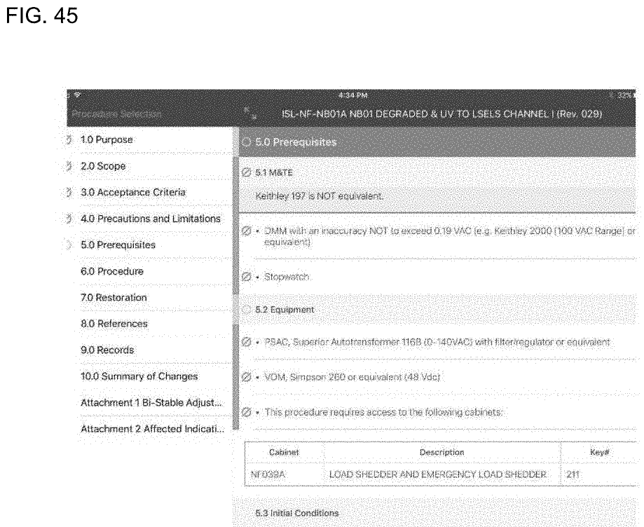

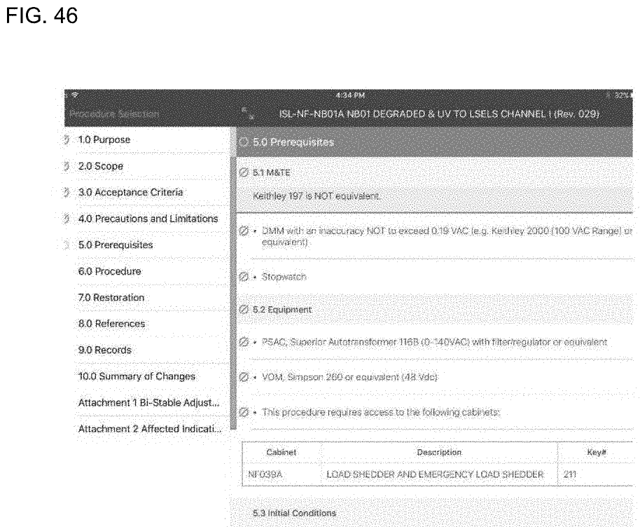

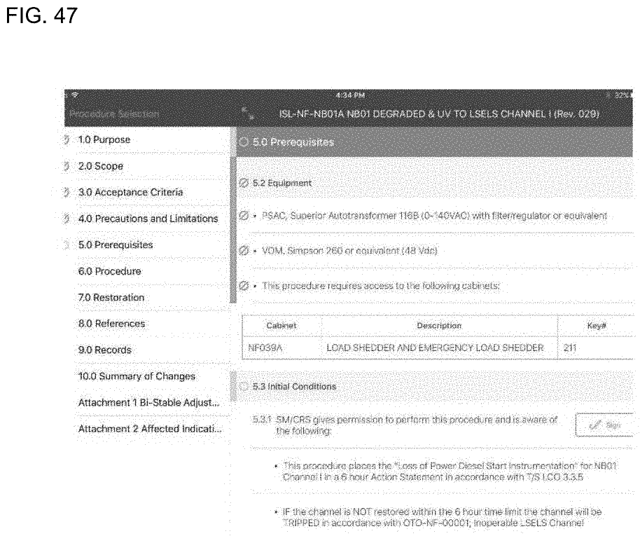

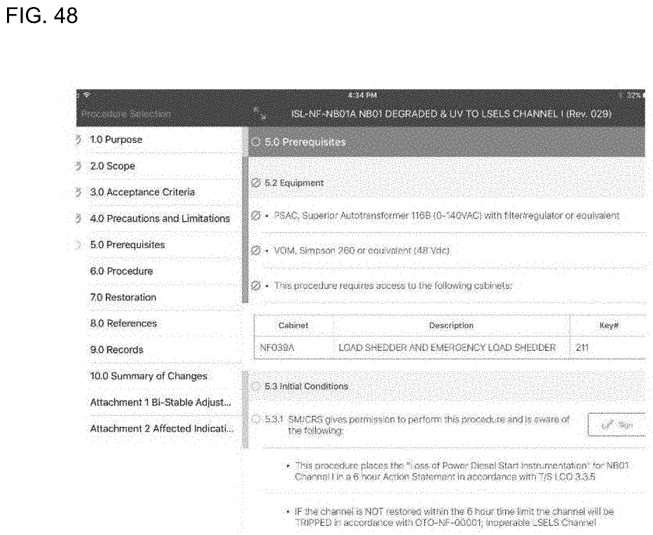

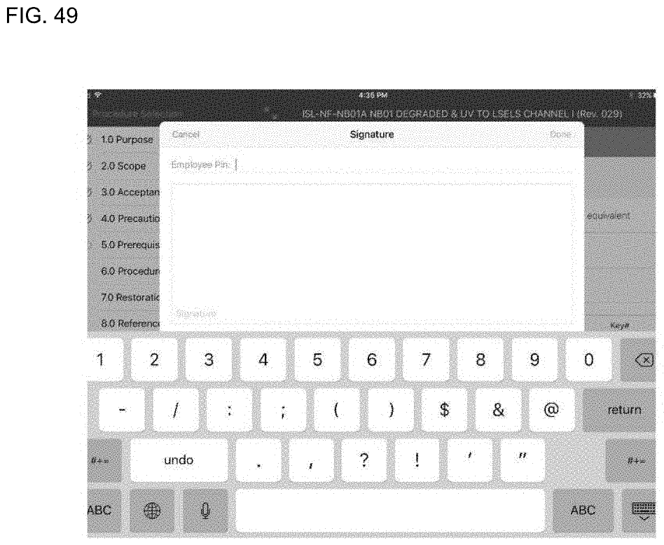

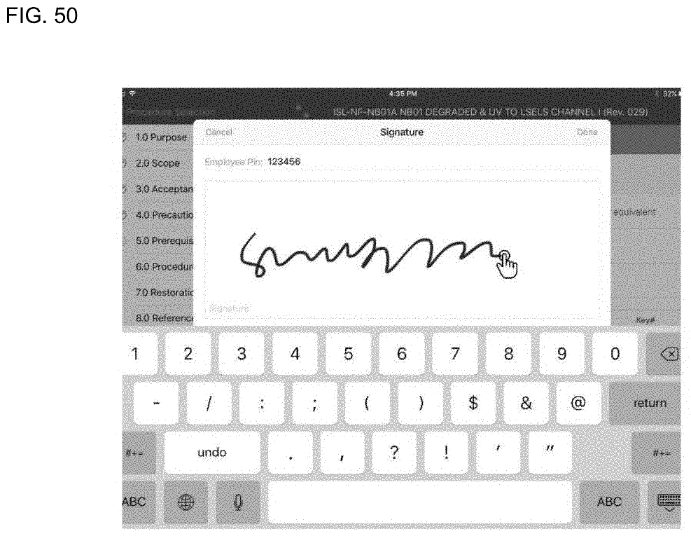

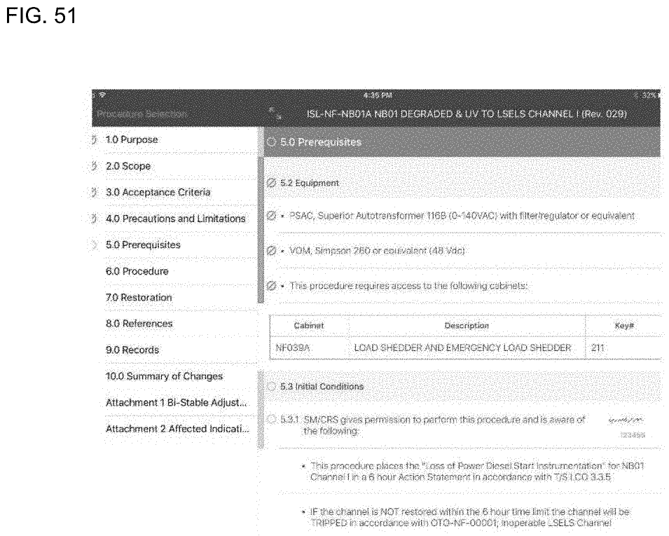

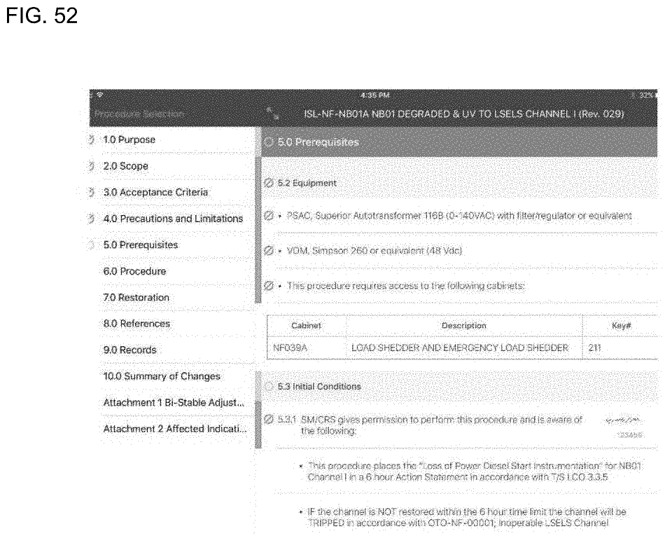

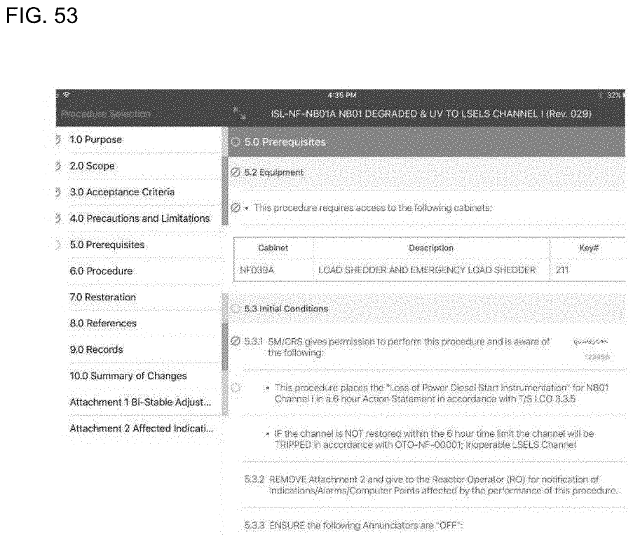

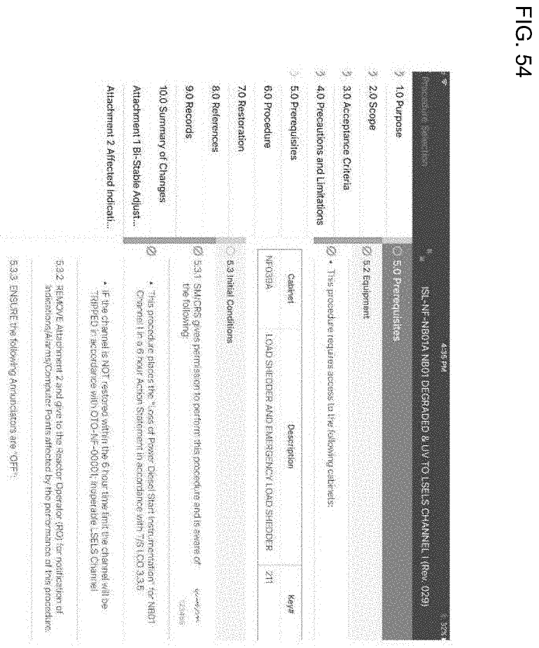

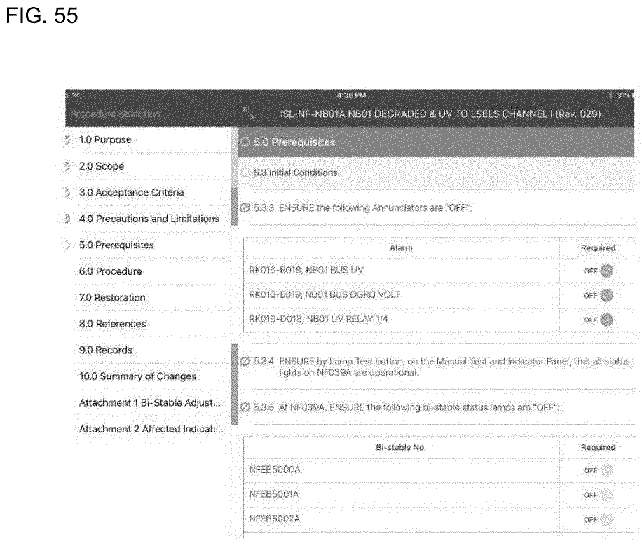

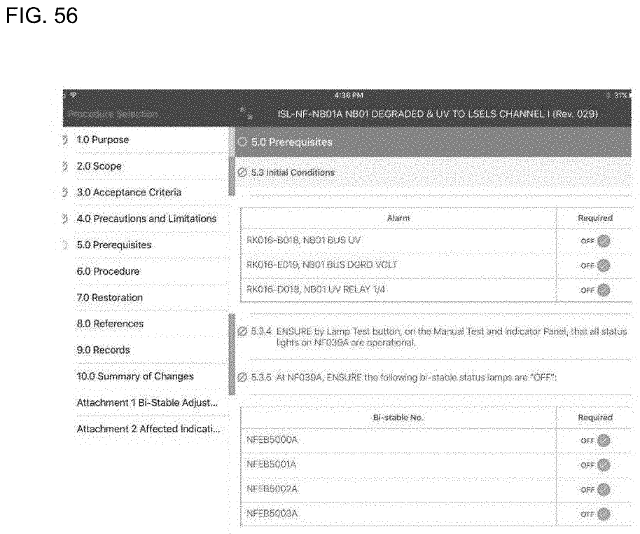

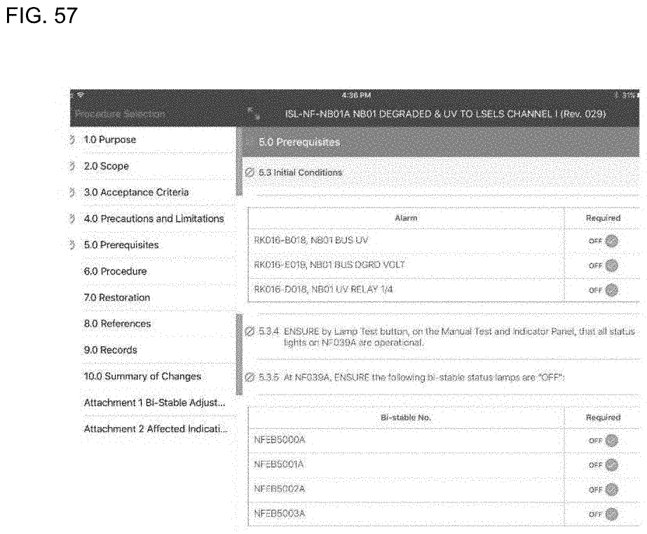

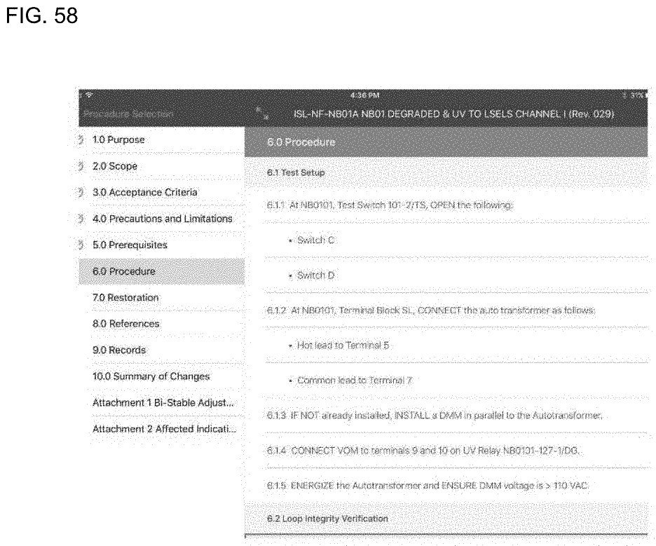

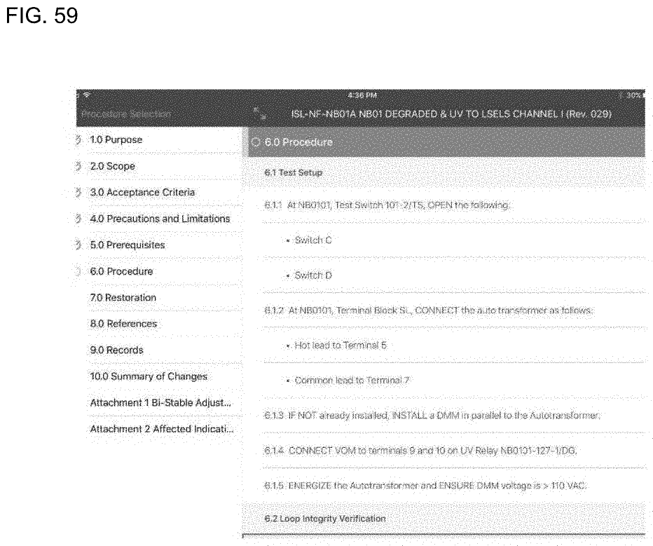

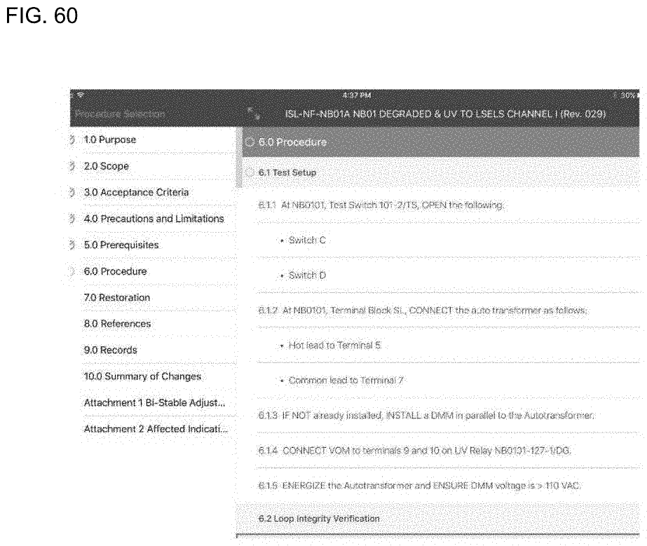

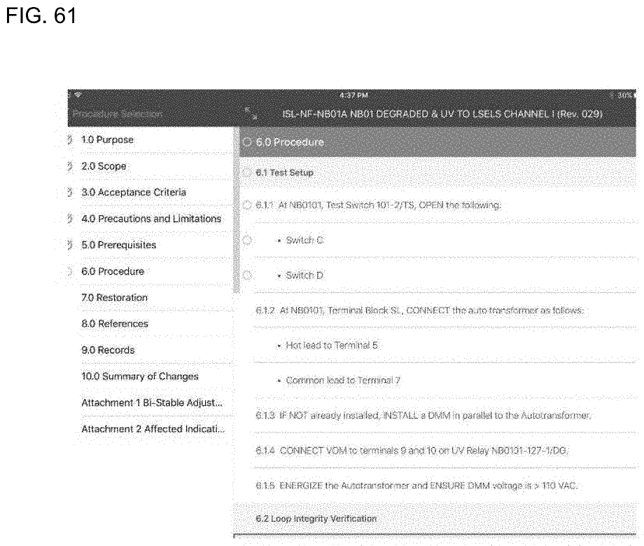

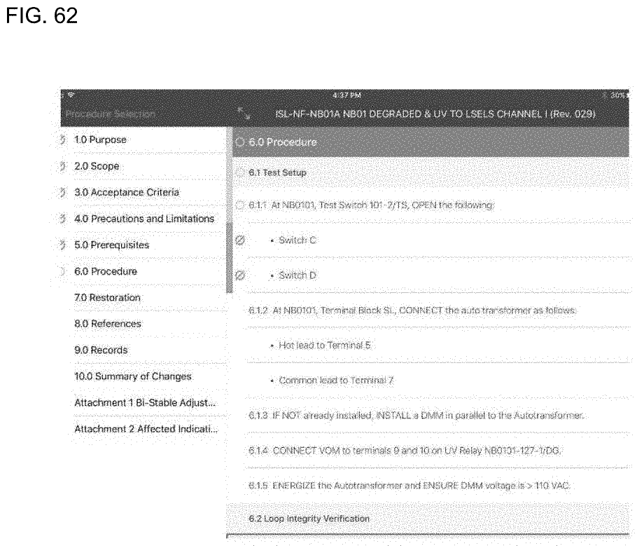

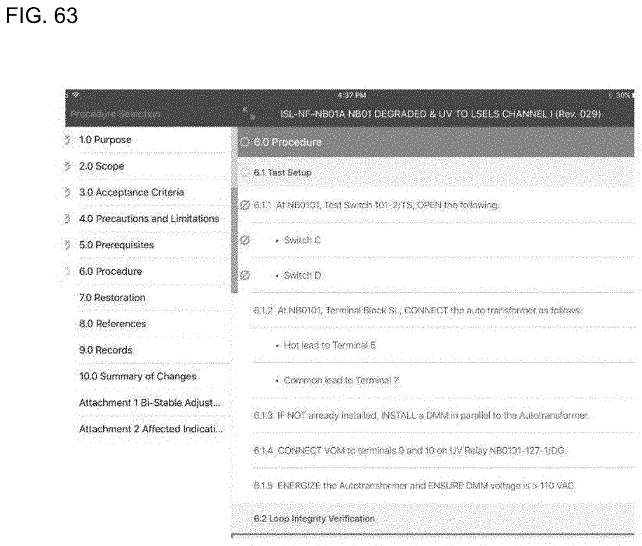

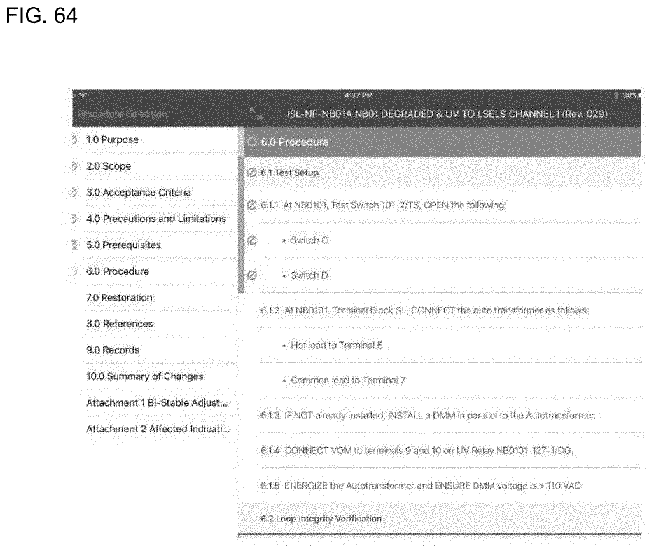

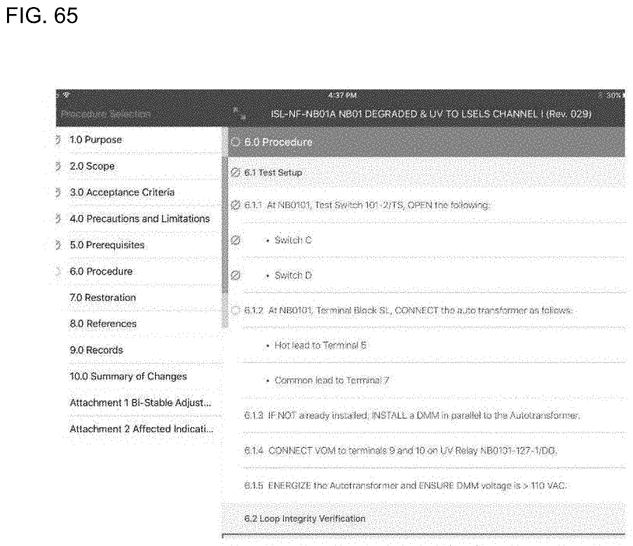

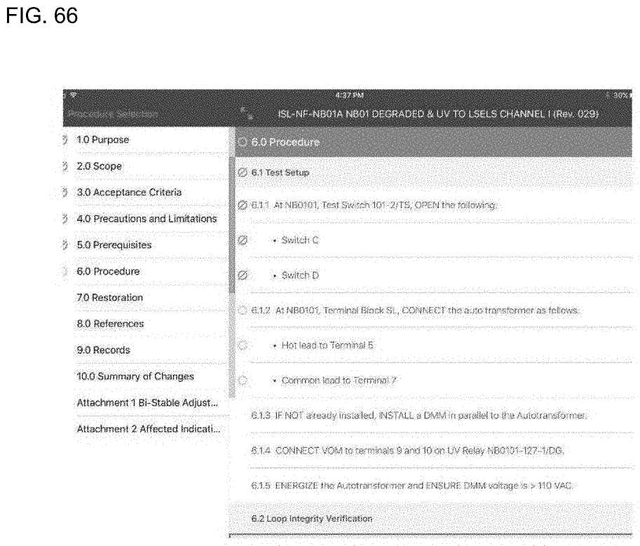

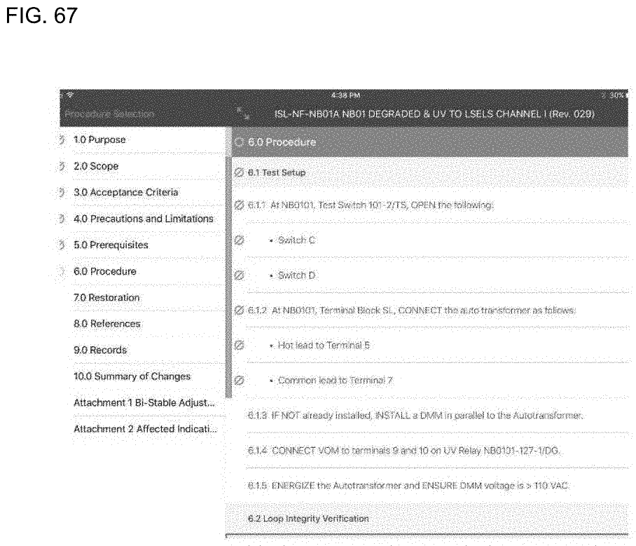

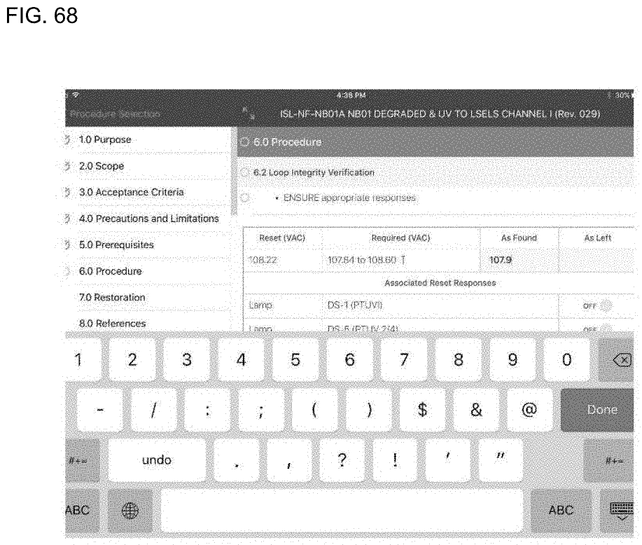

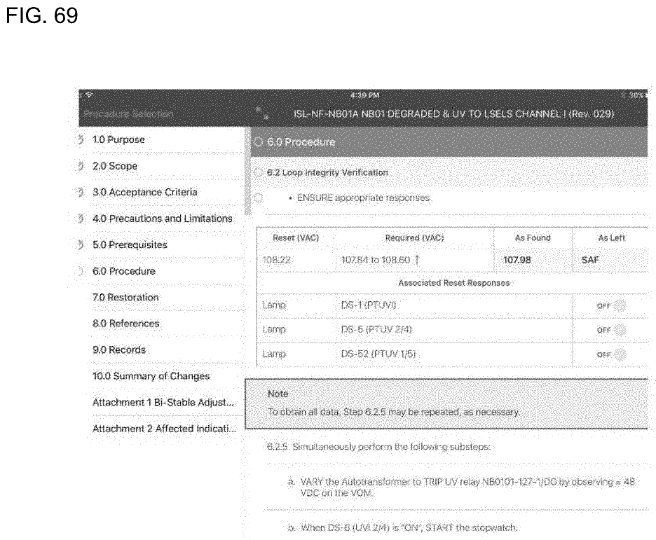

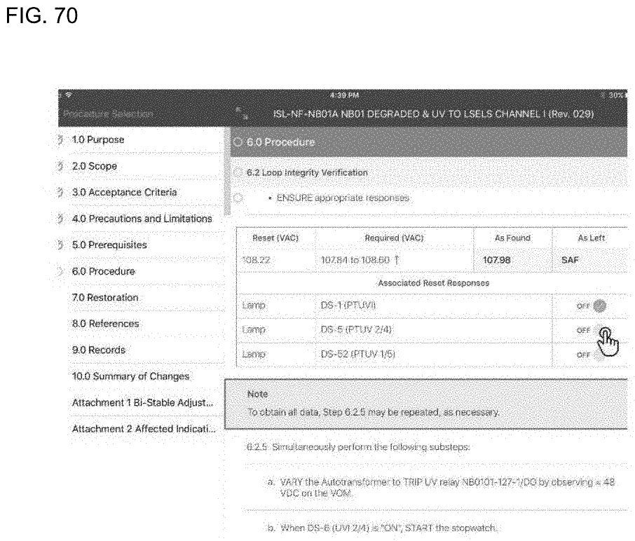

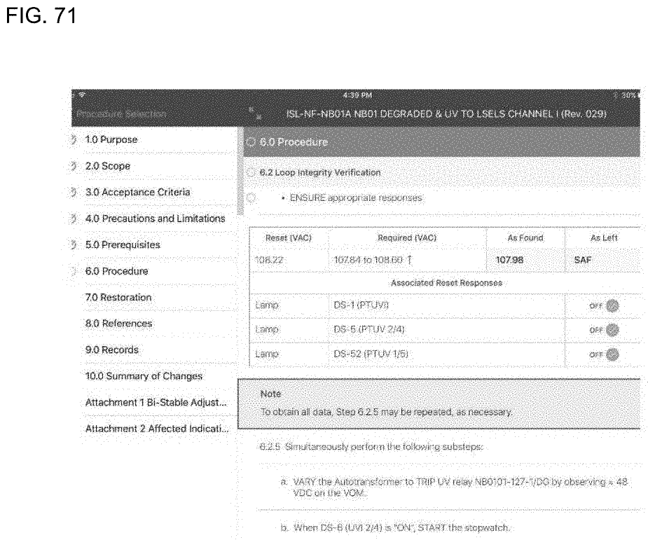

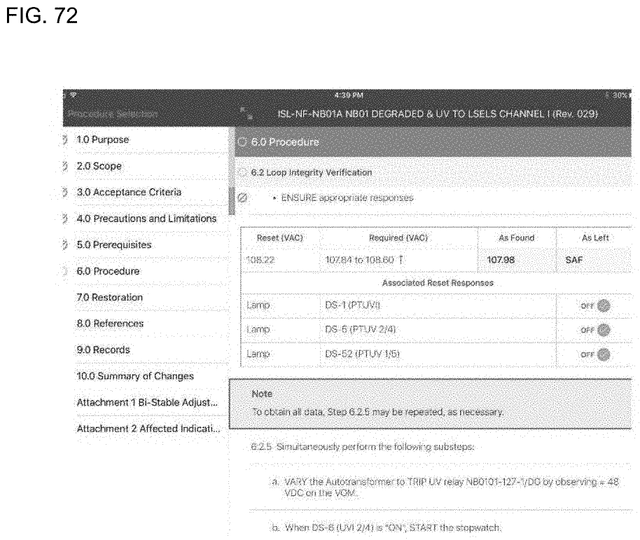

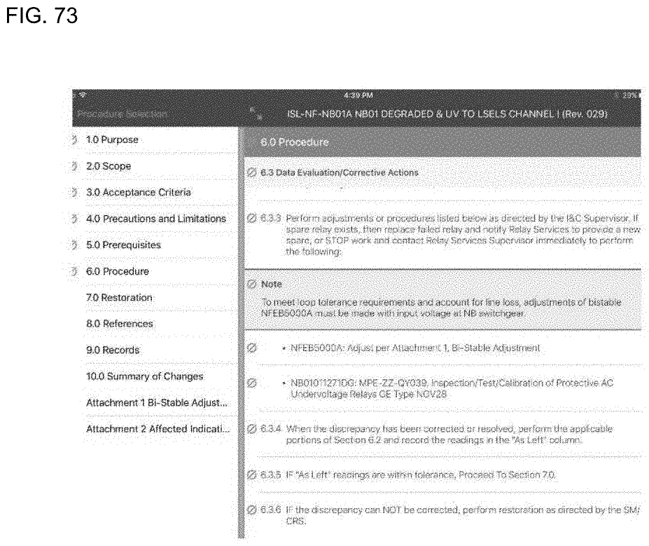

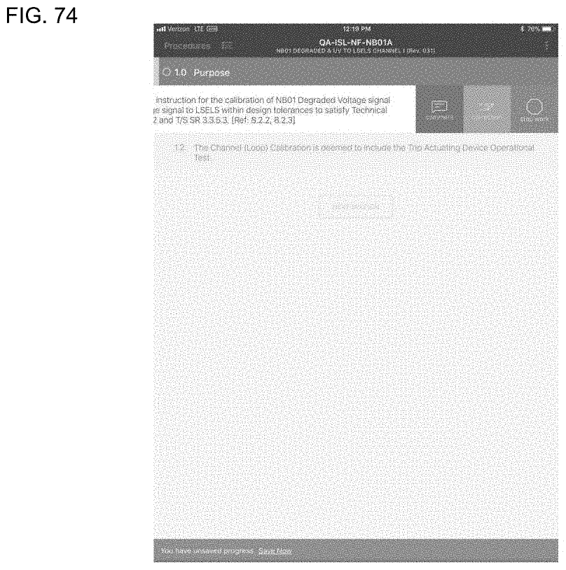

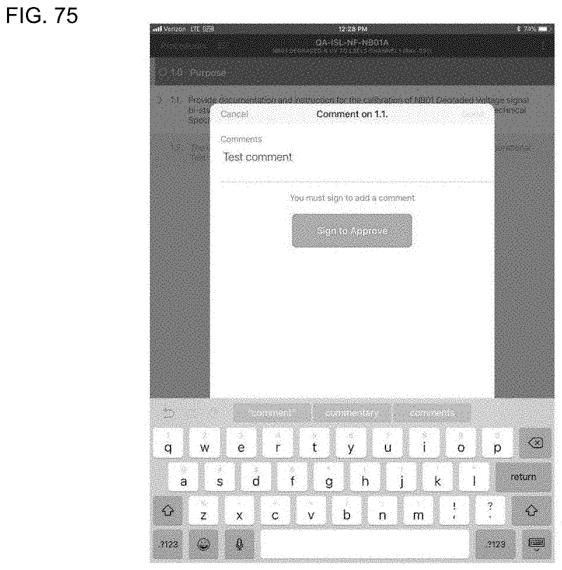

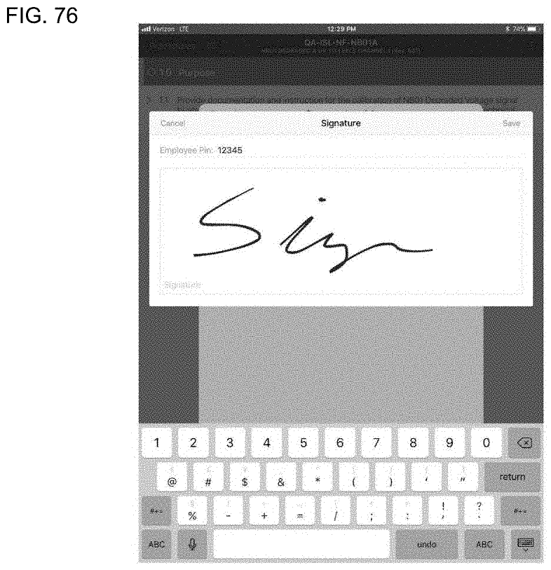

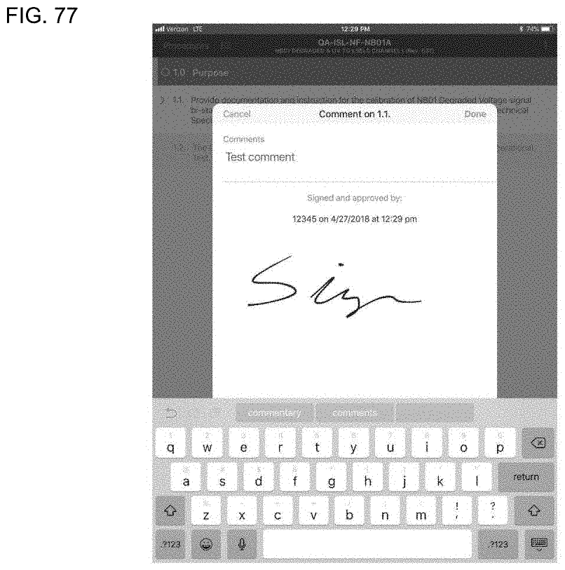

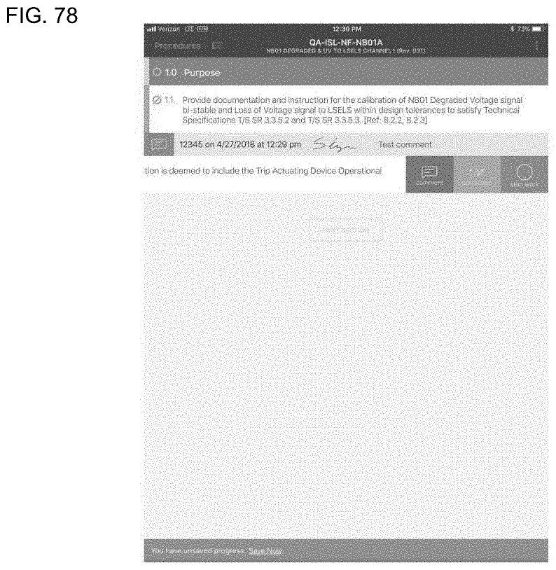

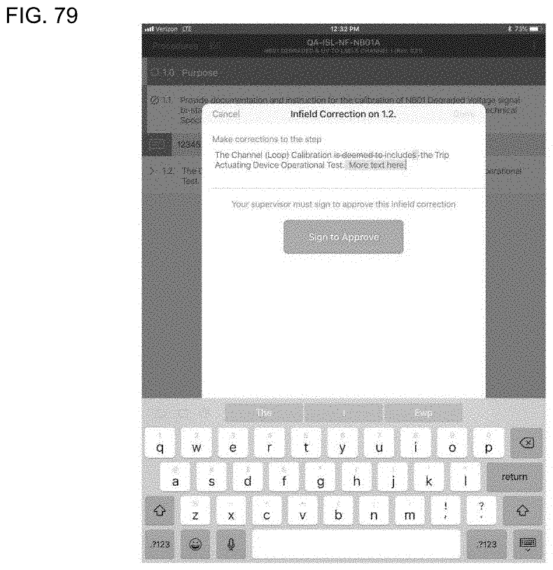

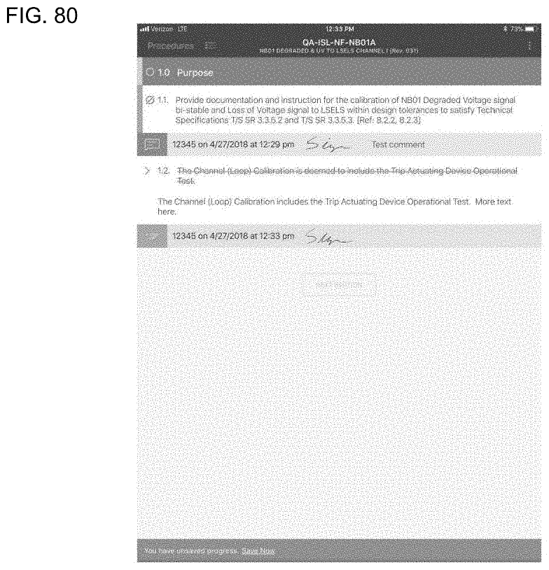

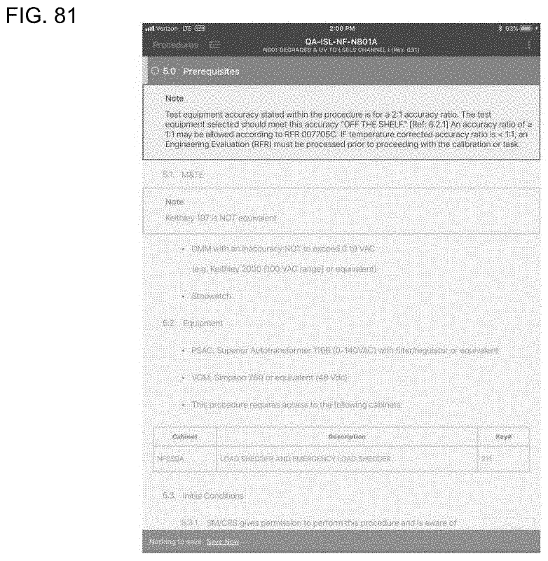

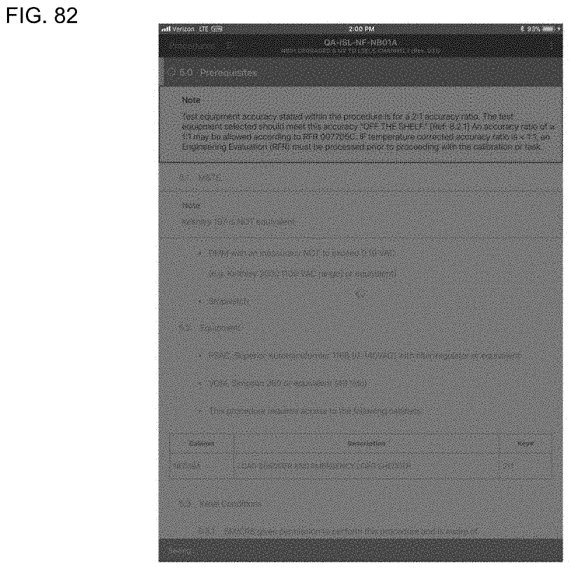

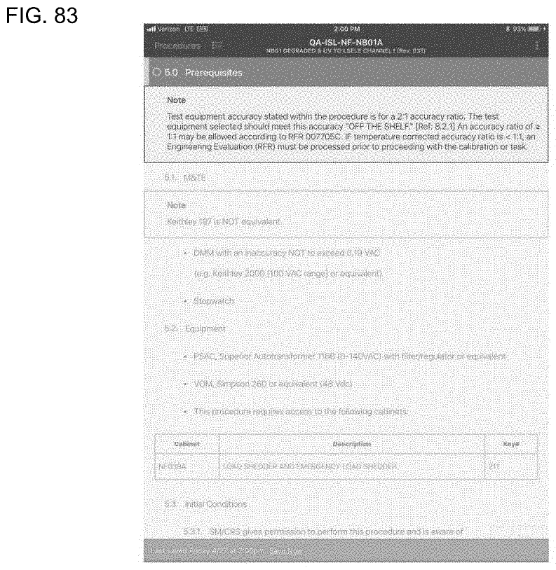

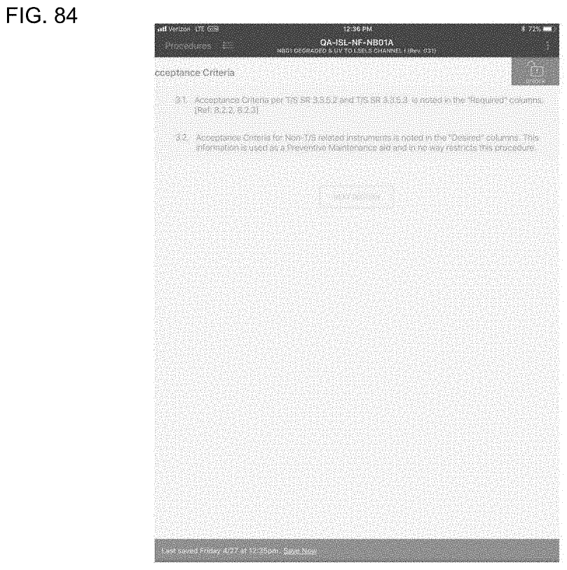

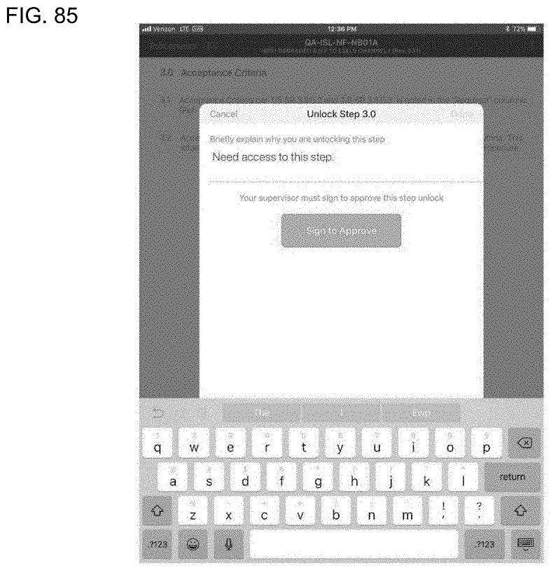

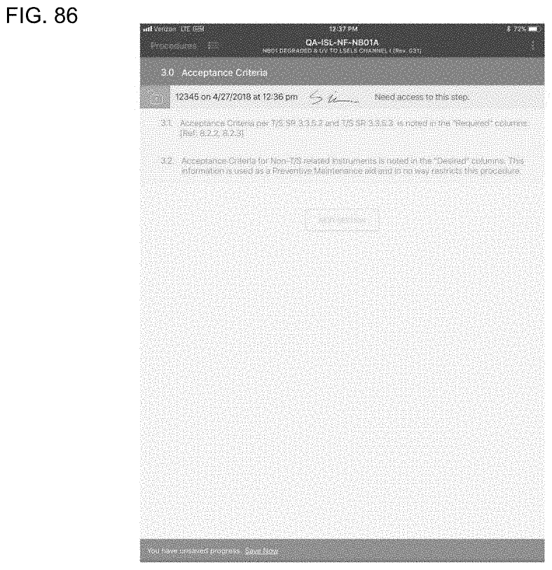

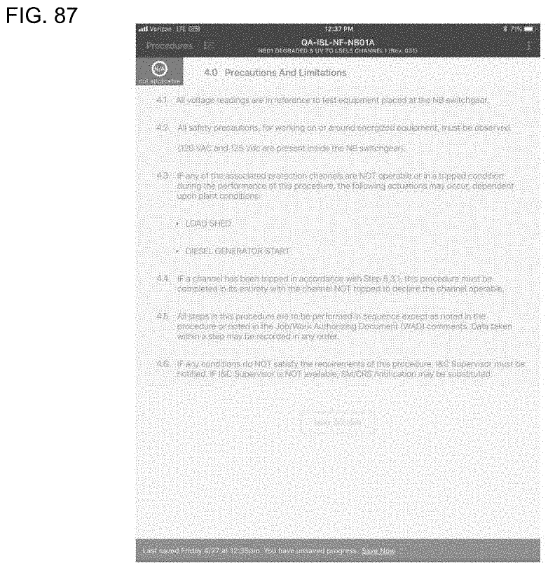

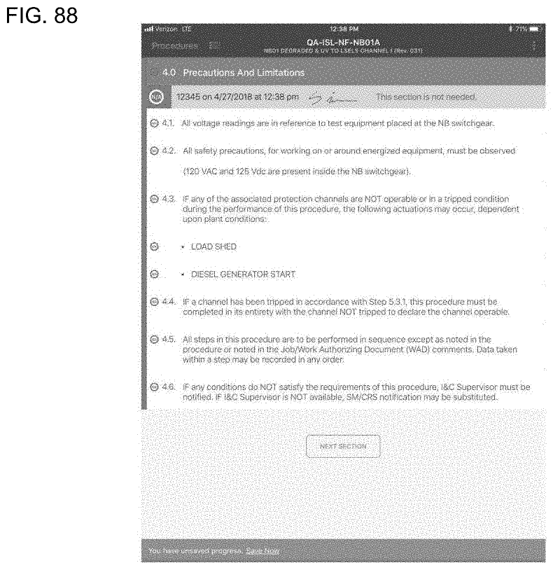

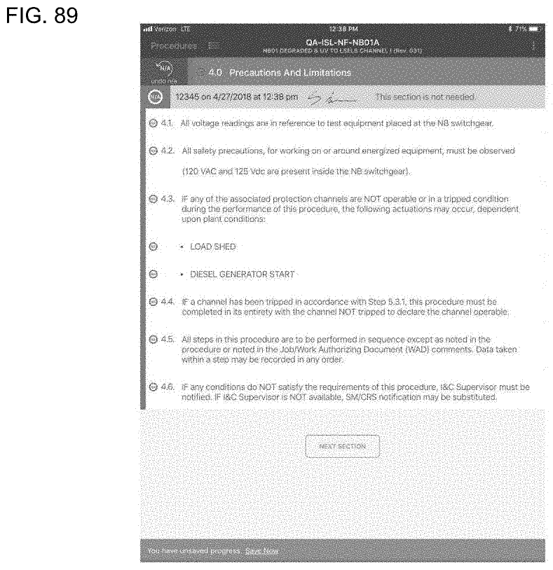

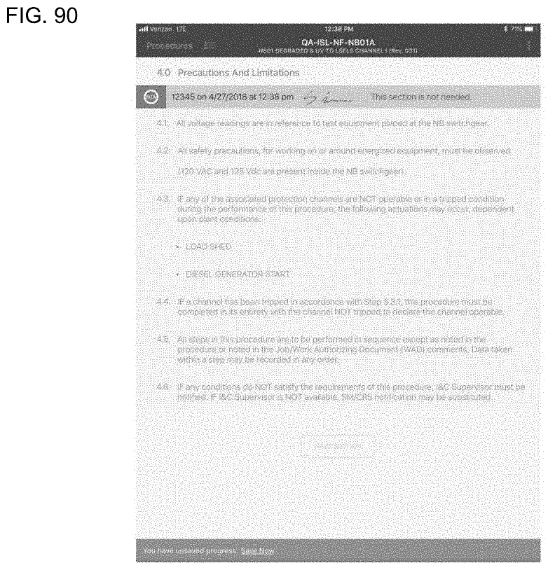

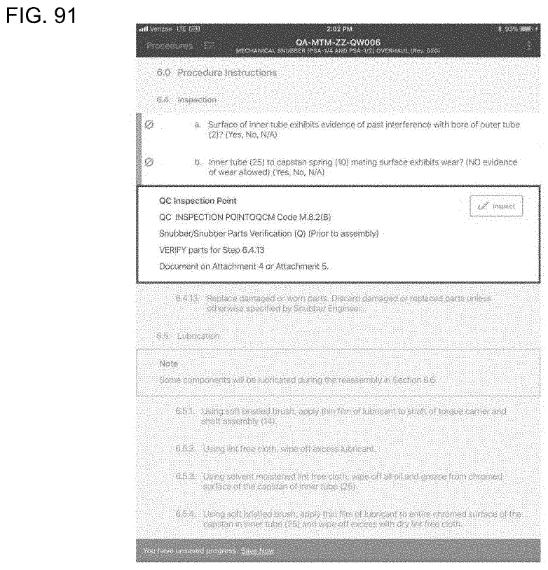

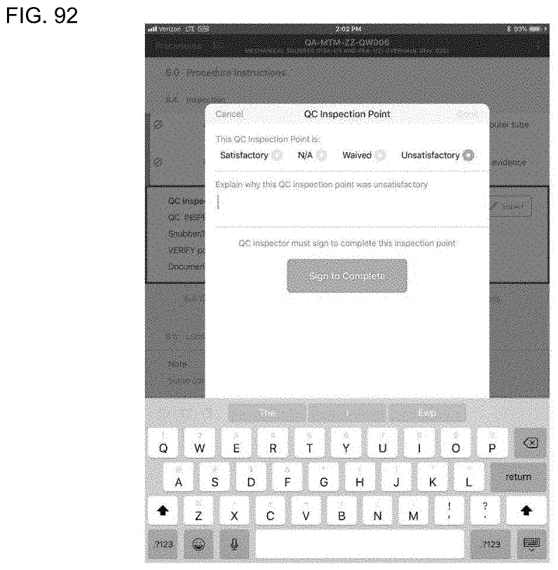

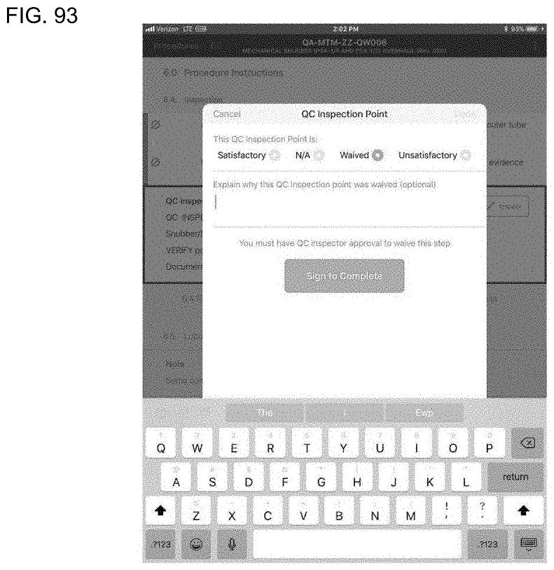

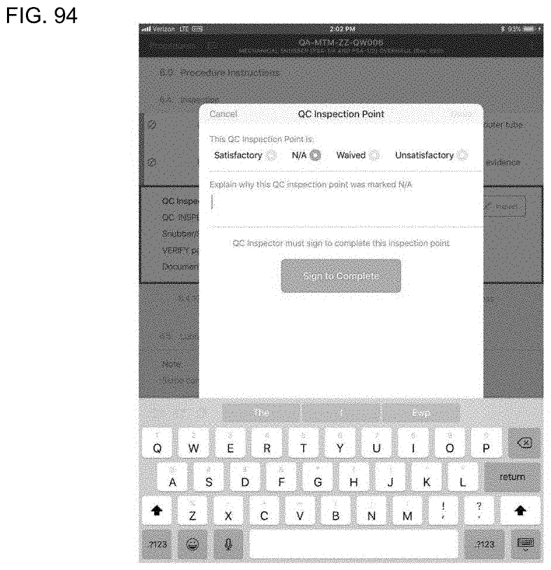

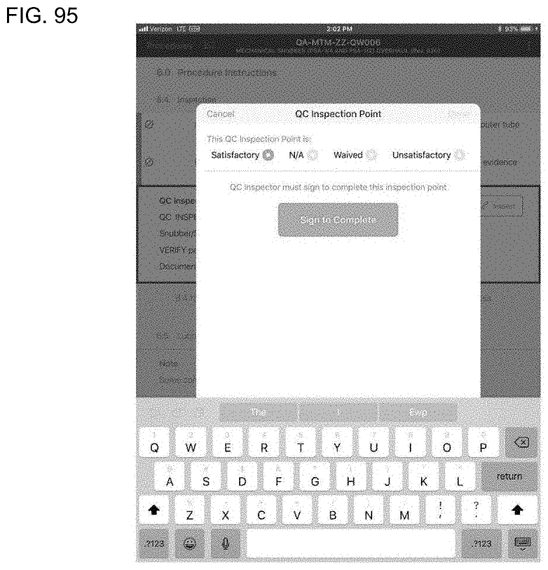

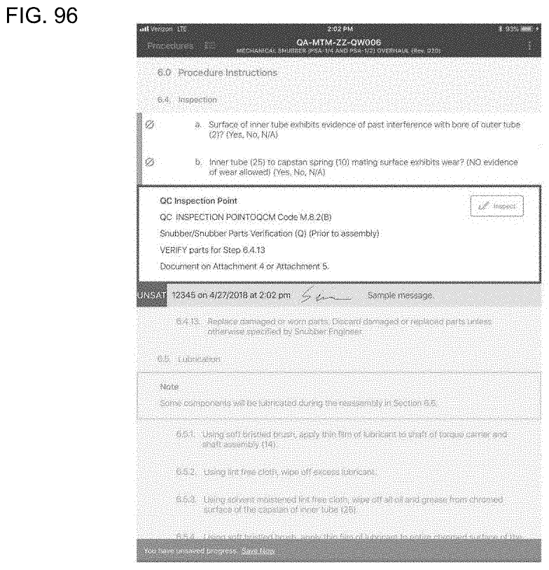

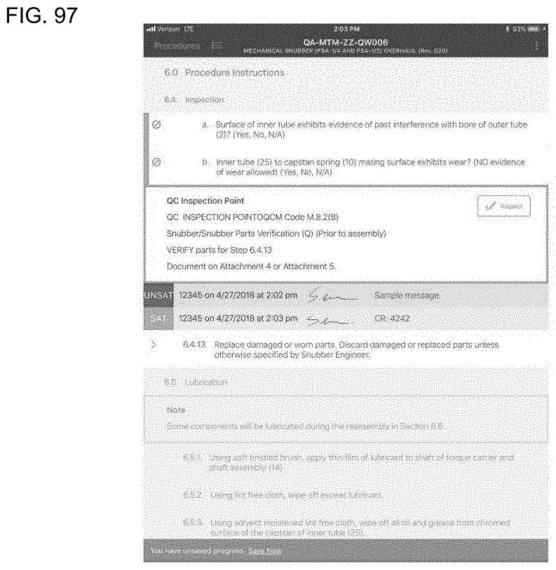

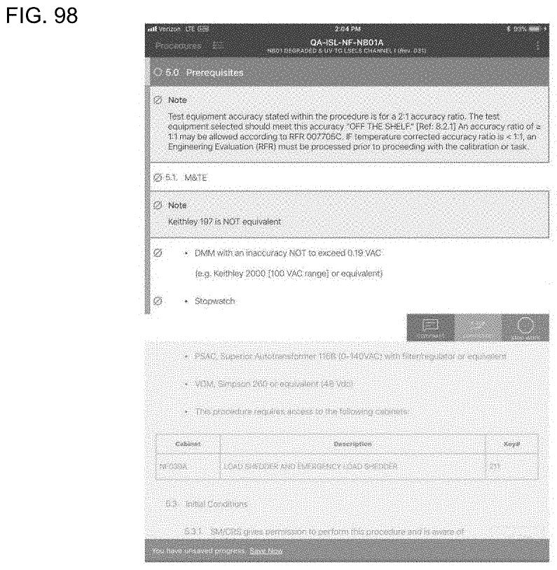

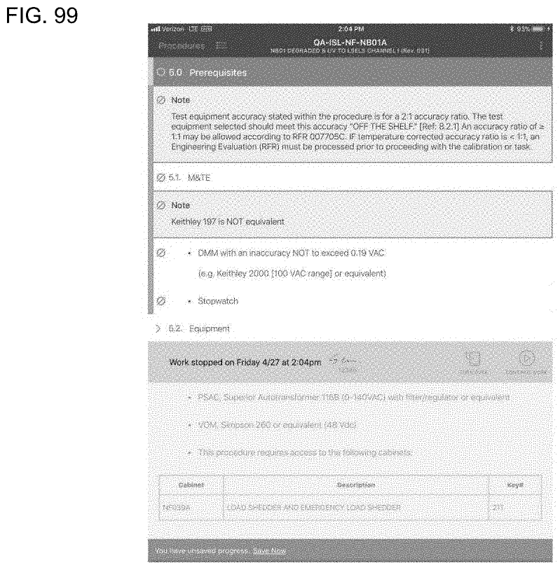

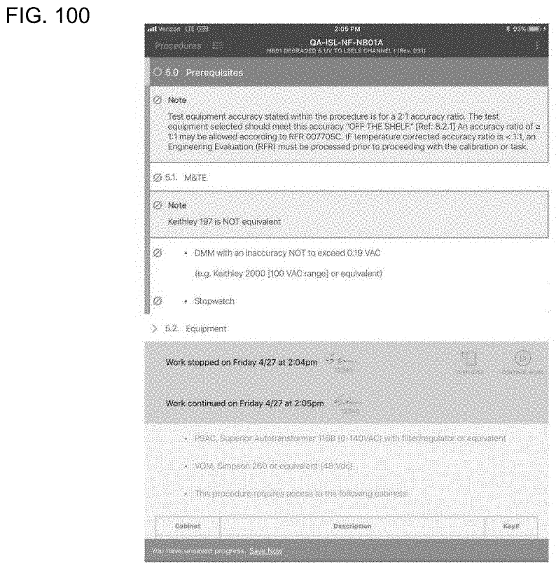

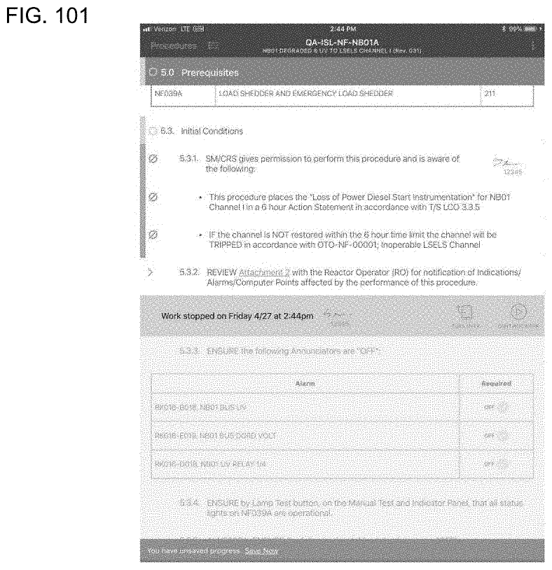

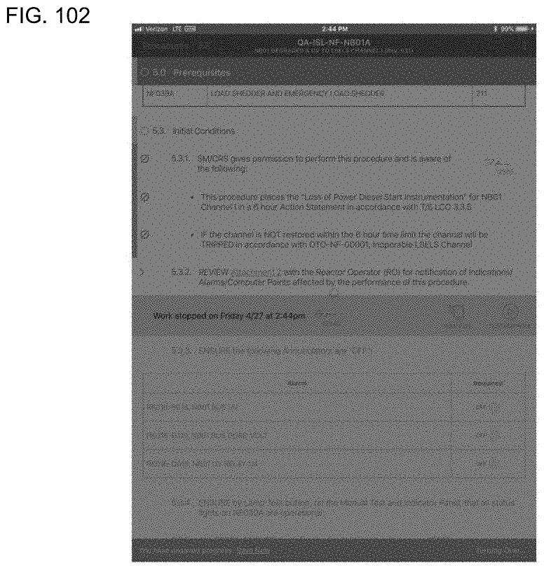

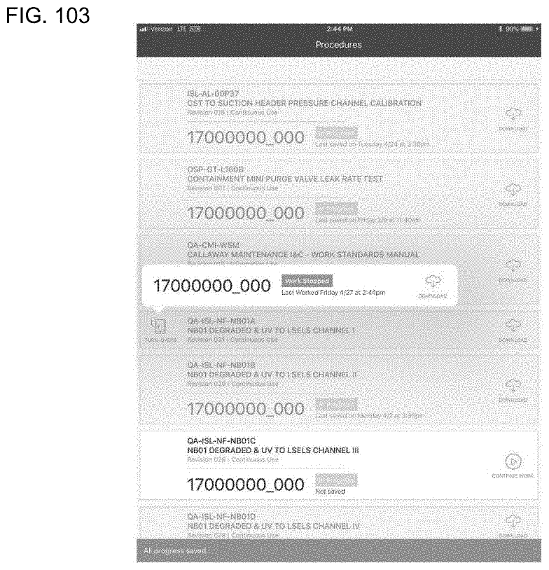

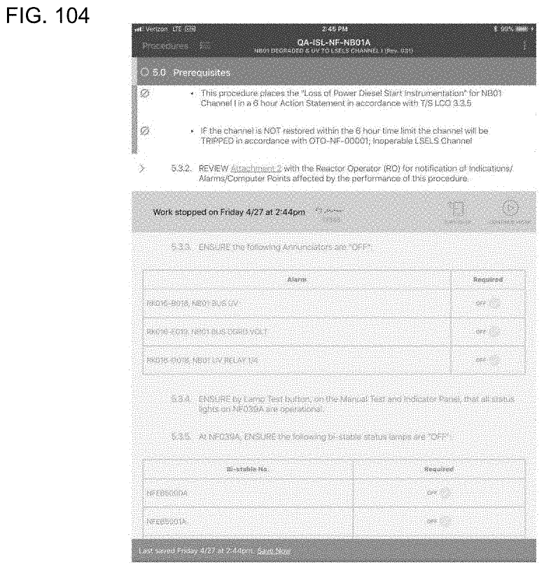

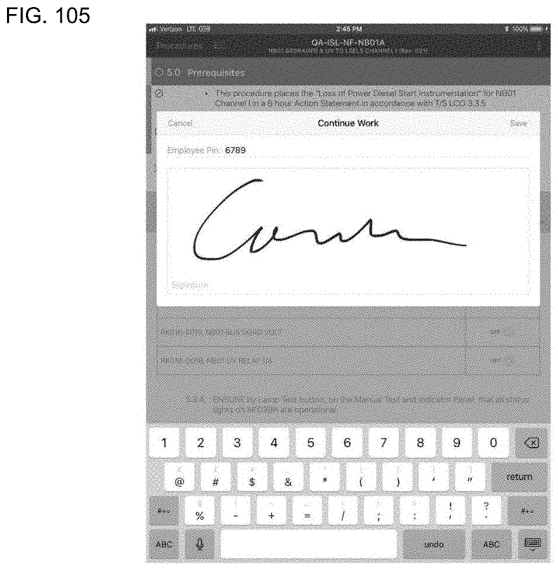

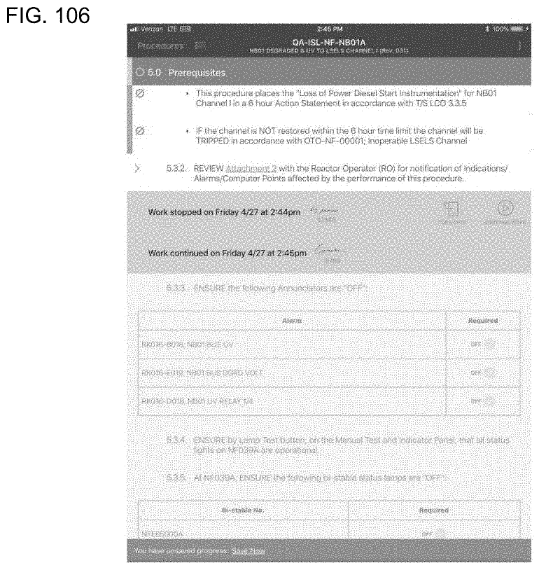

An example of a user experience of a work procedure mobile application 12 is shown in FIGS. 5-106. The illustrated work procedure mobile application 12 is configured to generate controlled workflows for a work procedure based on a .docx work procedure document that has been converted using the above-described work procedure converter 26 and stored in the work procedure database 20. As shown in FIG. 5, in one or more embodiments, the mobile application 12 presents a procedure selection view from which a user can select from the work procedures stored in the database 20. Selecting a procedure opens the work procedure in the mobile application 12. As shown in FIG. 6, the mobile application 12 initially navigates to the first section of the work procedure. In the illustrated embodiment, the mobile application 12 presents a list of the sections of the procedure (e.g., the highest levels in the hierarchical trees) to the left of the active section of the procedure.

In the illustrated embodiment, before providing any input to a step of the work procedure, the mobile application 12 prompts a user to swipe to activate the respective section as shown in FIG. 7. Requiring the user to activate a section prevents inadvertent markings. After swiping to activate the section, the illustrated mobile application 12 prompts the user to provide a first input to the mobile device 18 that indicates that work on the respective section has begun. As shown in FIG. 8, in one or more embodiments, the user taps a circle to the left of the section label to initiate work on the section. Those skilled in the art will appreciate that the use of a circle to the left of the section label is consistent with the industry standard approach to paper work procedures. After initiating the section, the circle becomes colorized (FIG. 9) so that the user is aware that the section is active.

As shown in FIGS. 10 and 11, while a section is active, the user can initiate a child step by swiping the step (broadly, providing an initiation input) and then activate the step by selecting the circle that appears upon initiation. The application also prompts the user to provide a completion input when the user completes each basic step or sub-step. As shown in FIG. 12, upon activation the circle adjacent the step becomes colorized to indicate that the step is active. After completing the step, the user can swipe the step as shown in FIG. 13 to call the mobile application 12 to present options for how to proceed. For example, in FIG. 14 the user is presented with a selectable icon that marks the step as complete when the user presses the icon. Selecting the icon is one example of providing completion input, though it will be understood that a mobile application 12 could prompt other types of completion inputs without departing from the scope of the invention. As shown in FIG. 15, the mobile application 12 then presents a slash through the circle to indicate that the step has been marked complete. Again, the slash through the circle is familiar syntax for users of work procedures in the nuclear power industry. Referring to FIGS. 16-18 the user can then proceed to repeat these steps for each of the additional steps in the section. As shown in FIGS. 19 and 20, to complete a section, the user swipes the section display item and selects the slashed-circle completion icon. As shown in FIG. 21, for a completed section, the illustrated mobile application 12 displays colorized slashed-circles adjacent each step and header.

Another exemplary section view is shown in FIG. 22. Generally, the mobile application 12 is configured to prompt the user to complete the section in the same manner/sequence as described above. For instance, the user first initiates and activates the section header, then initiates and activates the first step, then performs and completes the first step, then initiates, activates, performs, completes each subsequent step in sequence, then completes the section header. See FIGS. 23-25. It can be seen that in section 2.0, certain steps are associated with tables that provide information pertinent to the respective step. It will be appreciated that, in one or more embodiments, the mobile application 12 produces the displayed tables based on .docx tables from the source documents, identified, parsed, and converted using the work procedure converter 26.

Referring to FIG. 26, in one or more embodiments, the mobile application 12 is configured to present certain important information in a visual format that stands out from the typical format used for the steps. In the illustrated embodiment, the important information is presented as a note in a differently colored line item, but the important information could be presented/highlighted in other ways in other embodiments. The work procedure converter 26 could identify important information to be emphasized in the mobile application 12 by, for example, styles in the source document. For example, a business may have a business rule that requires stylizing important notes in a certain way in a .docx document and the work procedure converter could identify such text by metadata associated with the given style. As shown in FIG. 27-30, in the illustrated embodiment, the highlighted note functions in the mobile application 12 in the same way as a typical step. Referring to FIGS. 31-46, notes can be parent items to one or more subsection child items. The mobile application 12 can prompt the user to interact with the child subsection items in the same general way as for child step items under a header.

Those familiar with conventional pen-and-paper work procedures used in the nuclear industry will appreciate that certain steps must be authenticated via signature. There may also be a signature requirement for certain steps in work procedures for other industries. As shown in FIG. 47, when a signature is required for a given step or sub-step (a sub-step is shown), the mobile application 12 presents a signature button. Again, the user must initiate the sub-step (FIG. 48). After the sub-step is initiated a user can tap or select the signature button to call up a signature input window, as shown in FIG. 49. Using the touchscreen display of the mobile device 18, in one or more embodiments, the signature window prompts the user to enter an identifying PIN number (broadly, an authentication code) and a hand drawn signature to satisfy the signature requirement (FIG. 50). As shown in FIG. 51, after signing the signature and PIN number are displayed beside the sub-step. Further, in one or more embodiments, the user can then mark the sub-step complete (FIG. 52). In certain embodiments, the mobile application 12 prevents the user from marking a step with a signature requirement complete until a signature is properly received. As shown in FIGS. 53-54, the mobile application 12 prompts the user to proceed with the subsequent steps/sub-steps.

Referring to FIGS. 55-57, in certain embodiments, the mobile application 12 can be configured to present an interactive table for receiving user inputs. For example, in the illustrated embodiment, sub-steps 5.3.3 and 5.3.5 each present a table with items that the user must check off to complete the sub-step. The mobile application provides radio buttons to facilitate entry of check-off inputs in one or more embodiments, though other user interface functions could also be used. In one or more embodiments, the items in the table can be checked off in any order, and the mobile application 12 does not enforces a sequential workflow with respect to the items in the table. It will, however, be understood that a mobile application 12 could present interactive tables with selection items that must be addressed sequentially.

In general, the mobile application 12 may configured to enforce a sequential workflow. So for example, referring to FIGS. 58-60, in the procedure section 6.0, the mobile application 12 can prevent a user from initiating step 6.1 until section 6.0 has been initiated and can prevent a user from completing step 6.1 until all of the sub-steps 6.1.1-6.1.5 have been completed. However, in the illustrated embodiment, the mobile application 12 does not prevent a user from marking section 6.1 complete as shown in FIGS. 64-67. Broadly speaking, in one or more embodiments of a mobile application 12, the general rule is that (i) a child cannot be initiated until its parent has been initiated, (ii) a parent cannot be marked complete until all of its children have marked complete, and (iii) all children must be completed in a sequential order. Without departing from the scope of the invention, the mobile application 12 can enforce these rules strictly or loosely by permitting the user to opt out of the required sequence, e.g., after presenting the user with a warning that the preferred sequence is not being followed. Referring to FIGS. 84-86, in the illustrated embodiment, the enforced workflow can be superseded by selecting an unlock option from the menu. After selecting the unlock button, the user is presented with a text entry window which prompts the user to provide a reason for unlocking the enforced workflow sequence. After entering the reason, the illustrated mobile application 12 prompts the user to authenticate the reason. Specifically, the text entry window includes a ‘Sign and Approve’ button that calls up a signature input window (not shown) in which a user can enter a signature and/or a PIN when selected. After authenticating the reason, the enforced workflow is unlocked and the user can address one or more steps and/or sub-steps out of turn. As shown in FIG. 86, the mobile application 12 displays an unlock icon with the inputted reason to indicate that the enforced workflow has been unlocked.

As shown in FIGS. 61-63, the illustrated mobile application 12 also presents non-sequential steps or sub-steps, e.g., the sub-steps bulleted under sub-step 6.1.1. Again, the work procedure converter 26 can identify sequential and non-sequential steps and sub-steps based on styles or formatting in the source document. For example, numbered lists in a .docx document can be treated as sequential steps/sub-steps and bulleted lists can be treated as non-sequential.

Referring to FIGS. 68-73, in one or more embodiments, the mobile application 12 can be configured to prompt a user to provide one or more data inputs for a given step. So for example, as shown in FIG. 68, the ‘ENSURE’ sub-step of step 6.2 includes a table with a data entry field that prompts a user to input a measured value (VAC). It will be appreciated that the mobile application 12 can prompt a user to enter other types of data and/or enter data using other types of data entry fields. For example, as shown in FIG. 70, additional fields of the table provide radio buttons that must be selected to indicate that certain equipment is left off.

Referring to FIGS. 74-77, the illustrated mobile application 12 provides a user the option of entering a comment regarding any of the steps or sub-steps in a work procedure. In an exemplary embodiment, the user swipes the step in question to reveal a set of buttons corresponding with actions that can be performed in regards to the step. As shown, one of the buttons is a ‘COMMENT’ button in the illustrated embodiment. Pressing the ‘COMMENT’ button calls up a text entry window (FIG. 75). A user can enter comments via an onscreen alphanumeric keyboard or other text entry method. After writing the comment, in the illustrated embodiment, the user presses a button to sign and approve. Again, the user enters a signature and employee pin to authenticate the comment (FIG. 76). Pressing ‘Done’ after authenticating enters the comment in the application 12. As shown in FIG. 78, in the illustrated embodiment, the mobile application 12 displays the entered comment under the respective step.

Referring to FIGS. 78-80, the illustrated mobile application 12 further provides a user the option of entering a correction to any of the steps or sub-steps in a work procedure. As with the comment feature, in the illustrated embodiment, the user swipes the respective step to call up a correction button for the step (FIG. 78). Pressing the correction button calls up a text entry window prepopulated with text associated with the respective step or sub-step. The user makes the desired correction using a suitable text entry method and then selects the ‘Sign to Approve’ button to authenticate the correction (FIG. 79) and finally selects the ‘Done’ button to enter the correction into the application. As shown in FIG. 80, the mobile application 12 displays the entered correction by striking through the original description of the step and displaying the new description below.

Referring to FIGS. 81-83, in an exemplary embodiment, the mobile device 18 allows a user to save progress at any time when the device is connected to the internet. For example, the illustrated mobile application 12 continuously displays a bar along the bottom margin of the screen, which includes a ‘Save Now’ hyperlink. Pressing the hyperlink saves a user's input to the work procedure thus far. As shown in FIG. 82, the illustrated mobile application 12 indicates that a save is in progress by partially obfuscating the screen and displaying a spinner. After saving, the mobile application 12 includes a time stamp in the bottom display bar indicating the time of the last save operation.

Referring to FIGS. 87-88, steps or sub-steps can be marked not applicable so that the user may pass over them in the enforced work flow. To mark a step as not applicable, a user swipes right or requests a not applicable button from the mobile application 12. The mobile application 12 presents the not applicable button as shown in FIG. 88 and then the user can select the button to mark the step as not applicable. As shown in FIG. 88, the illustrated mobile application 12 is configured to automatically mark all child sub-steps as not applicable when any parent step or sub-step is marked not applicable. As with unlocking the work flow discussed above, after marking a step as not applicable, the mobile application 12 may require the user to enter a reason and authenticate the reason. In the illustrated embodiment, the mobile application 12 presents a circled ‘N/A’ beside each step and sub-step marked not applicable. In addition, the mobile application 12 displays a time-stamped reason entered for marking the step as not applicable.

Referring to FIGS. 89-90, the illustrated mobile application 12 also allows a user to undo the marking of a step as not applicable. For example, a user can swipe a marked-not applicable step right or otherwise request an undo not applicable button from the mobile device 18. In the illustrated embodiment, the mobile application 12 only allows a user to undo a not applicable marking at the level of the highest parent among the steps and sub-steps so marked. As shown in FIG. 90, after the marking a step as not applicable is undone, the displayed reason for the marking remains. This provides an indication to the user that the work flow sequence may not have been enforced with respect to the step in question.

Referring to FIGS. 91-97, the illustrated mobile application 12 is configured to present selected steps as quality control (QC) inspection steps. At each QC inspection step, the mobile application 12 displays an ‘Inspect’ button (FIG. 91). Pressing the button causes the mobile application 12 to present a QC Inspection Point window (FIG. 92). The illustrated QC inspection point window includes a list of options for the QC inspection point. In FIG. 92, the user has marked the QC inspection point ‘Unsatisfactory,’ so the QC Inspection Point window also displays a text entry field at which the user is prompted to enter a reason why the QC inspection point has been found unsatisfactory. In FIG. 93, the user has marked the QC inspection point ‘Waived,’ so the QC Inspection Point window also displays a text entry field at which the user is prompted to enter a reason why the QC inspection point has been waived. In FIG. 94, the user has marked the QC inspection point ‘N/A,’ so the QC Inspection Point window also displays a text entry field at which the user is prompted to enter a reason why the QC inspection point has been found not applicable. In FIG. 95, the user has marked the QC inspection point ‘Satisfactory,’ so the QC Inspection Point window requires no further explanation from the user. For each entry to the QC inspection point window, the mobile application 12 prompts the user to authenticate the entry via signature/employee access code. FIG. 96 illustrates an example of a QC inspection point marked unsatisfactory. As seen, the mobile application 12 displays ‘UNSAT,’ indicating the unsatisfactory designation, and also includes the user pin, signature, time stamp, and reason. Note that the subsequent step in the work flow is greyed out and has not been unlocked. FIG. 97 illustrates the mobile application 12 after a subsequent QC inspection finds the inspection point satisfactory (marked ‘SAT’). The following step (6.4.13) is now unlocked.

As shown in FIG. 98, when a user swipes left on a given step or sub-step, the illustrated mobile application 12 presents a set of buttons including a ‘STOP WORK’ button. Pressing the STOP WORK button allows the user to stop work on the work procedure, for example, if a user's shift is ending or the user is otherwise drawn away from the task. Suitably, the mobile application 12 can require a signature and PIN to finalize a STOP WORK. After stopping work, the mobile application 12 saves work in progress data to the database 24 and presents a stop work display item as indicated in FIG. 99. As shown in FIG. 100, the user can continue work after a stoppage by selecting the ‘CONTINUE WORK’ icon and providing a signature/PIN. Alternatively, referring to FIG. 101, if a second user is to pick up where the first left off, the user can select the ‘TURN OVER’ button. As shown in FIG. 102, pressing the TURN OVER button causes the mobile application 12 to save work in progress data and then check the procedure out of the mobile device 18 of the user. As shown in FIG. 103, the partially completed work procedure can then be downloaded by another user for completion. The next user takes the turned over procedure by pressing the ‘DOWNLOAD’ button. Referring to FIG. 104, the mobile application 12 then presents the work procedure to the user and navigates to the stop work entry created by the first user. The second user selects ‘CONTINUE’ and then enters a signature and PIN (FIG. 105). As shown in FIG. 106, the mobile application 12 displays a time-stamped indication that work was continued by a different user than the one who stopped the work.

As can be seen, in one or more embodiments the mobile application 12 includes features that facilitate the documented completion of a defined work procedure. As a brief summary, certain steps can have special properties that can require a user to provide additional inputs for completion. For example, some steps include data tables that prompt the user for measured value inputs. Other steps include signature lines or initials lines that prompt a user to provide a signature or initials input for verification/authentication to complete the step. Certain steps can require a qualitative assessment of the work being performed or the object being worked upon. It will be appreciated that the same type of specialized input fields will typically appear in the pre-conversion .docx work procedure from which the step model was created. For purposes of converting the pre-conversion .docx work procedure to the application-consumable format, these specialized fields in the pre-conversion work procedure can be identified using document styles and whitelist metadata. Using this metadata, the conversion tool can be configured to automatically create a data structure from which the mobile application 12 can generate a mobile prompt for the specialized input.

In one or more embodiments, the mobile application 12 is configured to require a user to complete each ordered step and all sub-steps thereof before proceeding to the subsequent step. Likewise, each ordered sub-step and any further child sub-steps thereof must be completed before proceeding to a subsequent sub-step at the same level. At any set of unordered steps or sub-steps, the application opens all of the unordered steps or sub-steps in the set to data entry at the same time.

The application can provide an override selection item that permits a user to override the default workflow, e.g., to proceed to a subsequent step or sub-step out of turn. For example, in one or more embodiments, the application can present an unlock selection item for one or more steps of the work procedure, which allows the user to override the default workflow rules. Similarly, in certain embodiments, the application presents an N/A selection item that permits a user to override the default workflow logic by marking a step or sub-step and all of its child sub-steps as inapplicable, thus permitting a user to skip the inapplicable step and move to the next applicable step or sub-step. Suitably, the mobile application 12 requires a user to provide a signature input and/or inputs describing a reason for overriding the default workflow whenever the default rules are overridden.

By default the application provides a selection item for each step and sub-step that permits the user to input a comment. In one or more embodiments, the user is required to provide a signature input for each comment.

In certain embodiments, the mobile application 12 can provide a selection item for one or more steps or sub-steps that permits a user to make a correction to the step or sub-step. The illustrated mobile application 12 requires a user to provide a signature input when any infield correction is made.

Whenever the mobile device 18 has a network connection, the mobile application 12 provides a selection item for saving the partial progress of the work procedure. When the user selects the partial save selection item, work in progress data is saved in the database 24. Work in progress data includes data for each of the user inputs received up to the point at which progress is saved.

The illustrated mobile application 12 is configured to present a stop-work selection item for indicating a given user has stopped work on the work procedure. After the stop-work selection item is selected, the mobile application 12 prompts the user to provide user credentials, as well as a date, time, and signature. The mobile application 12 stores a record that work has been stopped. The mobile application 12 can be configured to automatically provide the date and time data in one or more embodiments. After work is stopped on a work procedure, the mobile application 12 presents a continue work selection item and a turn over selection item to the user who stopped work on the work procedure. Selection of the continue work selection item allows the user to continue with the controlled workflow from the same point of progress. The application stores a record each time the continue work selection item is selected. If the turn over selection item is selected, progress on the procedure will be saved to the work procedure database 20. Mobile devices of other authorized users of the mobile application 12 can then download the partially completed work procedure and prompt the user to provide a signature to begin work on the partially completed work procedure. A turn over record is created for the turn over.

When introducing elements of the present invention or the preferred embodiments(s) thereof, the articles ‘a’, ‘an’, ‘the’ and ‘said’ are intended to mean that there are one or more of the elements. The terms ‘comprising’, ‘including’ and ‘having’ are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description shall be interpreted as illustrative and not in a limiting sense.

1. A work procedure conversion system, the work procedure conversion system comprising processor-executable software that when executed by a processor is configured to:
receive pre-conversion work procedure data in a pre-conversion format;
identify work procedure items in the pre-conversion work procedure data based on characteristics of the pre-conversion format; and
generate converted work procedure data in a converted format, wherein the converted work procedure data represents the identified work procedure items in the converted format.

2. A work procedure conversion system as set forth in claim 1, wherein the pre-conversion work procedure data comprises a multi-level list.

3. A work procedure conversion system as set forth in claim 1, wherein the pre-conversion format is .docx.

4. A work procedure conversion system as set forth in claim 1, wherein the pre-conversion work procedure data comprises XML data.

5. A work procedure conversion system as set forth in claim 1, wherein the software is configured to identify steps in the work procedure document based on a formatting characteristic.

6. A work procedure conversion system as set forth in claim 5, wherein the formatting characteristic comprises a style associated with a level of a multi-level list style.

7. A work procedure conversion system as set forth in claim 1, wherein the software comprises a parser that is configured to parse the pre-conversion work procedure data.

8. A work procedure conversion system as set forth in claim 1, wherein the software comprises a filter that is configured to remove some of the pre-conversion work procedure data.

9. A work procedure conversion system as set forth in claim 1, wherein the software comprises a tree builder that is configured to build an ordered hierarchical tree from the work procedure items.

10. A work procedure conversion system as set forth in claim 1, wherein the software comprises a parser that is configured to parse the pre-conversion work procedure data into a flat list of elements and a tree builder module that is configured to build an ordered hierarchical tree from the flat list of elements.

11. A work procedure conversion system as set forth in claim 1, wherein the work procedure document in the pre-conversion format comprises business-specific formatting characteristics.

12. A work procedure conversion system as set forth in claim 1, wherein the work procedure items comprises at least one of ordered steps, unordered-steps, ordered sub-steps, unordered sub-steps, verification fields, data input fields, or checkboxes.

13. A method of converting work procedure documents for a business, the method comprising:
identifying business-specific formatting characteristics of the work procedure documents for the business;
identifying steps in the work procedure documents of the business based on the business-specific formatting characteristics; and
generating a step model tree for each of the work procedure documents including an ordered sequence of step models representing the steps of the work procedure.

14. An electronic work procedure system comprising:
a memory storing a processor-executable work procedure application, the work procedure application being configured when executed by the processor to generate a controlled workflow for a work procedure on a mobile device, the workflow prompting a user to provide inputs to the mobile device indicating performance of steps in the work procedure.

15. An electronic work procedure system as set forth in claim 14, wherein the work procedure application is configured to prevent the user from providing an input for a subsequent step of the work procedure until an input for a prior step is received.

16. An electronic work procedure system as set forth in claim 14, wherein the work procedure application is configured to retrieve the work procedure from a remote work procedure database.
